(19) United States
(12) Patent Application Publication
(10) Pub. No.: US 2023/0183867 A1
(43) Pub. Date: Jun. 15, 2023

(54) ELECTROCHEMICAL SYNTHESIS OF METAL SUPERHYDRIDES

(71) Applicant: Carnegie Mellon University, Pittsburgh, PA (US)

(72) Inventors: Venkatasubramanian Viswanathan, Pittsburgh, PA (US); Pin-Wen Guan, Pittsburgh, PA (US)

(21) Appl. No.: 17/925,918

(22) PCT Filed: May 21, 2021
(86) PCT No.: PCT/US2021/033628

§ 371 Date: Nov. 17, 2022

Related U.S. Application Data
(60) Provisional application No. 63/110,669, filed on Nov. 6, 2020.
(60) Provisional application No. 63/059,672, filed on Jul. 31, 2020.
(60) Provisional application No. 63/028,265, filed on May 21, 2020.

(51) Int. Cl. C25B 1/01; C01B 6/02; C25B 15/031; C25B 11/081; C25B 9/19

(52) U.S. Cl. CPC C25B 1/01; C01B 6/02; C25B 9/19; C25B 11/081; C25B 15/031

(57) ABSTRACT

Processes for producing a metal superhydride include obtaining a metal or metal alloy electrode comprising one or more metal atoms, obtaining an electrolyte comprising hydrogen atoms, the electrolyte configured to kinetically suppress a hydrogen evolution reaction in the metal electrode, disposing the metal electrode in the electrolyte, applying pressure to the metal electrode and the electrolyte while the metal electrode is disposed in the electrolyte, and forming, based on applying the pressure, a metal superhydride comprising a plurality of hydrogen atoms of the electrolyte being bonded to each of the one or more metal atoms of the metal electrode. Generally, the metal superhydride is stable at a pressure less than 100 gigapascal (GPa).

### CLAIM OF PRIORITY

This application claims priority under 35 U.S.C. §119(e) to U.S. Pat. Application Serial No. 63/028,265, filed on May 21, 2020, to U.S. Pat. Application Serial No. 63/059,672, filed on Jul. 31, 2020, and to U.S. Pat. Application Serial No. 63/110,669, filed on Nov. 6, 2020, the entire contents of each of which are hereby incorporated by reference.

### TECHNICAL FIELD

This specification describes metal superhydrides and the synthesis of metal superhydrides.

### BACKGROUND

Hydride systems (such as Palladium-hydrogen, Lanthanum-hydrogen, yttrium-hydrogen, lithium-magnesium hydrogen, etc.) have attracted research interests due to importance in both fundamental science and technological applications. Superhydrides have been studied for potential applications in superconductivity, hydrogen uptake, and low-energy nuclear reactions.

### SUMMARY

Superconducting materials (materials that can conduct electricity without any electrical resistance) are useful for a large number of applications. However, generally, superconducting materials are stable either at low temperatures, high pressures, or both.

In a general aspect, a process for producing a metal superhydride includes obtaining a metal electrode comprising one or more metal atoms; obtaining an electrolyte comprising hydrogen atoms, the electrolyte configured to kinetically suppress a hydrogen evolution reaction in the metal electrode; disposing the metal electrode in the electrolyte; applying pressure to the metal electrode and the electrolyte while the metal electrode is disposed in the electrolyte; and forming, based on applying the pressure, a metal superhydride comprising a plurality of hydrogen atoms of the electrolyte being bonded to each of the one or more metal atoms of the metal electrode, the metal superhydride being stable at a pressure less than 100 gigapascal (GPa).

In some implementations, the process includes adjusting, using the electrolyte, an activity of the plurality of hydrogen atoms in the metal electrode; adjusting, based on the activity of the plurality of hydrogen atoms, kinetics of reactions of the plurality of hydrogen atoms at interfaces of the metal electrode and the electrolyte; and causing, based on the kinetics of the reactions, the plurality of hydrogen atoms of the electrolyte to be bonded to each of the one or more metal atoms of the metal electrode.

In some implementations, a number of hydrogen atoms in the plurality of hydrogen atoms that are being bonded to each of the one or more metal atoms is a function of a potential of the metal electrode. The process includes applying the potential of the metal electrode to cause the metal superhydride to include a particular number of hydrogen atoms in the plurality, the particular number of hydrogen atoms being between 2 and 12 and inclusive of 2 and 12.

In some implementations, a number of hydrogen atoms in the plurality of hydrogen atoms that are being bonded to each of the one or more metal atoms is based on of a pH of the electrolyte. The process includes adjusting the pH of the electrolyte to cause the metal superhydride to include a particular number of hydrogen atoms in the plurality, the particular number of hydrogen atoms being between 2 and 12 and inclusive of 2 and 12.

In some implementations, the plurality of hydrogen atoms form an anion having a linear geometry. In some implementations, the plurality of hydrogen atoms form an anion having a planar geometry. In some implementations, the plurality of hydrogen atoms form an anion having a three dimensional (3D) geometry.

In some implementations, the metal electrode comprises Palladium, and wherein the plurality of hydrogen atoms comprises at least three hydrogen atoms. In some implementations, the plurality of hydrogen atoms comprises twelve hydrogen atoms.

In some implementations, the electrode comprises at least one of: Lithium, Carbon, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon.

In some implementations, the electrolyte comprises a proton-conducting membrane. In some implementations, the proton-conducting membrane is selected from a group consisting of: an aqueous electrolyte solution, a polymer electrolyte membrane, a proton-conducting ceramic electrolyte, and a solid acid proton conductor.

In some implementations, the pressure is less than 1 GPa. In some implementations, the pressure is less than 500 MPa.

In some implementations, the one or more metal atoms of the metal electrode are a subset of all metal atoms of the metal electrode.

In a general aspect, a metal electrode device includes metal atoms forming a lattice; and a plurality of hydrogen atoms bonded to each of the metal atoms, wherein the plurality of hydrogen atoms are loaded into the lattice from an electrolyte configured to kinetically suppress a hydrogen evolution reaction, wherein lattice is maintained at a pressure less than 100 gigapascal (GPa).

In some implementations, a number of hydrogen atoms in the plurality of hydrogen atoms that are being bonded to each of the metal atoms is a function of a potential of the lattice. In some implementations, the potential is between 0 and -1 volts on the reversible hydrogen electrode scale.

In some implementations, a number of hydrogen atoms in the plurality of hydrogen atoms that are being bonded to each of the metal atoms is a function of a pH of the electrolyte. In some implementations, the plurality of hydrogen atoms form an anion having a linear geometry. In some implementations, the plurality of hydrogen atoms form an anion having a planar geometry. In some implementations, the plurality of hydrogen atoms form an anion having a three dimensional (3D) geometry.

In some implementations, the lattice comprises Palladium, and wherein the plurality of hydrogen atoms comprises at least three hydrogen atoms. In some implementations, the plurality of hydrogen atoms comprises exactly twelve hydrogen atoms. In some implementations, the lattice comprises at least one of: Lithium, Carbon, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon.

In some implementations, the electrolyte comprises a proton-conducting membrane.

In some implementations, the proton-conducting membrane is selected from a group consisting of: an aqueous electrolyte solution, a polymer electrolyte membrane, a proton-conducting ceramic electrolyte, and a solid acid proton conductor.

In some implementations, the pressure is less than 1 GPa. In some implementations, the pressure is less than 500 MPa. In some implementations, the metal atoms of the lattice are a subset of all metal atoms of the lattice. In some implementations, the plurality of hydrogen atoms comprises between 2 and 12 hydrogen atoms inclusive of 2 and 12 hydrogen atoms.

In some implementations, the lattice comprises Palladium, wherein at least one metal atom of the lattice is bonded to ten of the hydrogen atoms to form PdH₁₀, and wherein the pressure is less than 200 MPa. In some implementations, the lattice comprises Yttrium, wherein at least one metal atom of the lattice is bonded to nine of the hydrogen atoms to form YH₉, wherein the pressure is approximately 1 MPa, and wherein the lattice is at an electric potential of approximately -0.2 volts on the reversible hydrogen electrode scale.

In some implementations, the lattice comprises Lanthanum, wherein at least one metal atom of the lattice is bonded to eight of the hydrogen atoms to form LaHs, wherein the pressure is approximately 1 GPa, and wherein the lattice is at an electric potential of approximately -0.2 volts on the reversible hydrogen electrode scale.

In some implementations, the lattice comprises Magnesium, wherein at least one metal atom of the lattice is bonded to sixteen of the hydrogen atoms to form MgH₁₆, wherein the pressure is approximately 100 MPa, and wherein the lattice is at an electric potential of approximately -0.2 volts on the reversible hydrogen electrode scale.

In some implementations, the lattice comprises Calcium, and wherein at least one metal atom of the lattice is bonded to six of the hydrogen atoms to form CaH₆.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a block diagram of an example computing environment for modeling structures of metal superhydrides.

FIGS. 2A and 2B show Radial Distribution Function (RDF) of low enthalpy structures of all the studied compositions of palladium-hydrogen under 0 GPa and 150 GPa.

FIG. 3 shows a flow diagram including an example process for producing a metal superhydride.

FIGS. 4A, 4B, 5A, and 5B show predictions for palladium superhydride structures and c-values as shown from the model of FIG. 1.

FIGS. 6A-6B show results of structure search for (a) PdH8, (b) PdH10, (c) PdH12 at 0 GPa and PdH12 (d) top and (e) side view.

FIG. 7 shows a graph illustrating a distribution of the minimum H-H distances of the low enthalpy structures under 0 GPa and 150 GPa for the palladium-hydrogen system.

FIG. 8 shows composition-dependent topological features of the low enthalpy structures under (a) 0 GPa and (b) 150 GPa of palladium hydrogen. The coordination number describes the number of H atoms coordinated to Pd, and the dimensionality is used to describe the framework formed by the Pd polyhedrons.

FIG. 9A shows Radial Distribution Function (RDF) of ground states of PdH₁₂ with the Cmcm space group at 150 GPa most probable calculated by the Bayesian Error Estimation Functional (BEEF).

FIG. 9B shows a charge density distribution of ground states of PdH12 with the Cmcm space group at 150 GPa most probable calculated by BEEF.

FIG. 9C shows a density of states (DOS) and partial density of states (PDOS) of ground states of PdH12 with the Cmcm space group at 150 GPa most probable calculated by BEEF.

FIG. 10 shows Pourbaix diagrams by BEEF ensembles at (a) 0 GPa and (b) 150 GPa.

FIGS. 11-13 show U-P diagrams for (11) Pd—H, (12) Y-H and La—H, (13) Mg—H and Ca—H.

FIG. 14 shows an example computing system.

Like reference numbers and designations in the various drawings indicate like elements.

FIGS. 15A-15D show pressure-dependent Pourbaix diagrams of Li—Mg—H by the best-fit BEEF-vdW functional at 300 K. The dashed line represents the equilibrium HER (hydrogen evolution reaction).

FIG. 16 shows a graph representing pressure-dependent enthalpies of three ground states of Li₂MgH₁₆.

FIG. 17 shows crystal structures of three ground states of Li₂MgH₁₆ at different pressures.

FIG. 18 shows pressure-dependent H—H separation in H₂ dimers and excess charge per H₂ dimer of Li₂MgH₁₆ by the best-fit BEEF-vdW functional at 300 K.

### DETAILED DESCRIPTION

This specification describes electrochemical synthesis of metal superhydrides. More specifically, this specification describes methods for producing metal superhydrides that are both stable at relatively low pressures, such as less than 1 Gigapascal (GPa) and at relatively high temperatures, such as above 200 degrees Kelvin to approximately 400 degrees Kelvin. In some implementations, the metal superhydrides described in this specification can be used as superconductors. The superhydrides described herein can be made with hydride (H-) ion conductors in addition to protons (H+).

Metal superhydrides can include metals in which more than one proton (hydrogen atom), but generally at least three protons are bonded to each metal atom (or a subset of the metal atoms) in a metal lattice. For example, a metal lattice can include metal atoms in which at least three protons and up to twelve protons are bonded to each of those metal atoms. In some implementations, the metal can be an alloy of at least two metals.

A process for forming these metal superhydrides is now described. A metal (such as a metal electrode or metal lattice) is subjected to a hydrogen gas under a pressure. The exact pressure used depends on the chosen metal (e.g., Palladium, Lithium, Lanthanum, Yttrium, Scandium, Calcium, Magnesium and others subsequently described). The pressure also depends on the electrochemical process which is subsequently described. Examples of different pressures for different metals are subsequently described in following examples. The pressure process enables a metal lattice (e.g., metal atoms) to be loaded with more than one hydrogen atom bonded to each metal atom. A pressure process can be used to load hydrogen atoms into the metal lattice. For example, hydrogen gas is sent into the metal at a high pressure.

The process further includes an electrochemical process in combination with putting the metal under pressure. The electrochemical process enables lower pressures to be used during the pressurization of the metal. This facilitates development of the metal superhydride, as high pressures can be difficult to work with and can produce unstable materials. For example, without the electrochemical process being used in combination with the pressure process, in some implementations, the pressure required for generating metal superhydrides could be about 150 GPa or more. This process can also be costly and difficult to scale up to produce large numbers of metal super hydrides. The electrochemical process allows the metal hydrides to be produced and remain stable at lower pressures, including pressures as low as several hundred megapascals (MPa).

The electrochemical process is now described. The metal electrode is dipped or placed in a water and salt mixture (e.g., an electrolyte). An electric potential, typically between approximately -0.2 volts (V) and -1 V, on the reversible hydrogen electrode scale is applied to the metal electrode. The hydrogen is loaded in to the metal under these conditions. Typically, hydrogen naturally loads into the metal under these conditions under ambient pressure, but generally no more than 1 hydrogen atom is bonded to each metal atom. For example, PdH can be formed using electrochemical processes alone, but not PdH However, when performing the electrochemical process to the metal electrode under pressure (e.g., on the order of several hundred MPa to a few GPa), metal superhydrides can be formed.

Generally, combining the electrochemical process and the application of pressure to the metal electrode can generate, from the metal electrode, many different kinds of metal superhydrides. The parameters of the pressure and the electric potential for producing each specific example can vary depending on the metal chosen. Generally, these materials can be produced at ambient temperatures (e.g., about 300 degrees Kelvin).

### Example Implementations

Palladium-hydrogen system has long attracted research interests due to its importance in both fundamental science and technological applications. It has been studied for potential applications in superconductivity, hydrogen uptake, and low-energy nuclear reactions. Experimentally, the highest hydride phase synthesized is Pd₃H₄, under high pressure conditions.

There is now great interest in metal hydrides produced under pressure that include significantly higher amounts of hydrogen, including superhydrides (defined as MHₙ, for n > 6) first synthesized in the La—H system as guided by theoretical calculations. The phase stability of higher hydrides of Pd as a function of pressure and electrochemical loading can be analyzed using density-functional theory (DFT)-based structure search methods. The dependence of the results on the choice of exchange correlation functional is shown.

A metal hydride electrochemical phase diagram includes superhydrides and provides an approach to accessing potentially novel Pd—H phases having high hydrogen content. It could be feasible to electrochemically load PdH₁₀ when combined with moderate-pressure. Moderate-pressure electrochemistry is a frontier area of extreme conditions materials science.

The phase stability of Pd—H phases from ambient pressure to megabar (>100 GPa) are explored using density-functional theory combined with the CALYPSO structure search method. The Bayesian Error Estimation Functional (BEEF-vdW) is employed to provide a confidence value (c-value) over these competing phases to avoid possible bias due to selection of a particular DFT functional, which has been successfully applied to calculate thermodynamic properties and phase diagrams. In order to more robustly assess the ground state within the structure search, an ensemble of functionals within the Bayesian Error Estimation Functional formulation to identify the predicted ground state. Thus, each functional identifies a particular ground state for a given composition and c-value quantifies what fraction of the functionals identify that structure as having the minimum energy.

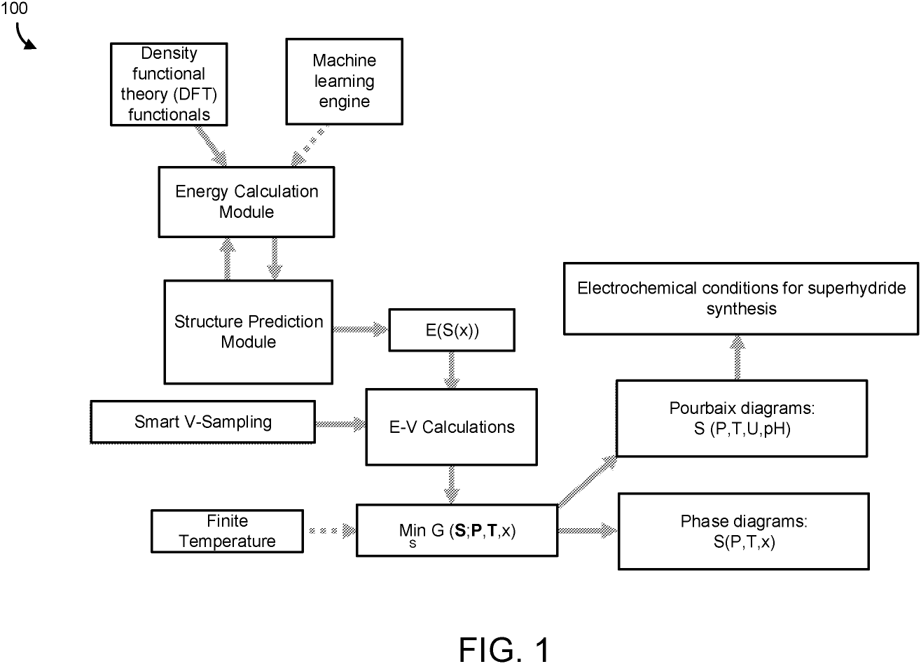

FIG. 1 shows an environment 100 for modeling potential structures for metal superhydrides. The energy of a structure can be calculated using density functional theory (DFT) or using machine learning (ML) potentials. A structure predictor, e.g. Calypso, generates a new structure, S, whose energy is evaluated at different volumes, marked as E-V calculations. These calculations can then be used to calculate the Gibbs Free Energy, G(S,p,T,x) which is minimized over all possible structures S. Using the Gibbs Free Energy, pressure phase diagrams S(p,T,x) as well as Pourbaix diagrams S(p,T,U,pH) can be generated which leads to identifying the conditions needed for the electrochemical synthesis of superhydride structures. A structure search performed for the two experimentally assessed compositions at ambient and high pressure: PdH and Pd₃H₄. For PdH, there are several structures that are quite close in energy. A confidence value (c-value) diagram is used to assess which of the structures may be probable ground states. The most probable predicted ground state of PdH has the R3m space group with tetrahedral coordination. However, this structure only has a c-value of around 0.4, indicating that at the GGA-level DFT, it is not possible to conclusively identify the true ground state. The experimentally reported Fm-3m rocksalt structure is found to be one of the possible structures, though it has a lower c-value (about 0.05). At high pressure (150 GPa), the rocksalt structure is found to be the most probable (using the prediction model) with a high c-value indicating at the GGA-level theory, at this pressure, it is certain that this is indeed the true ground state. These results are consistent with experimental measurements reported up to 100 GPa.

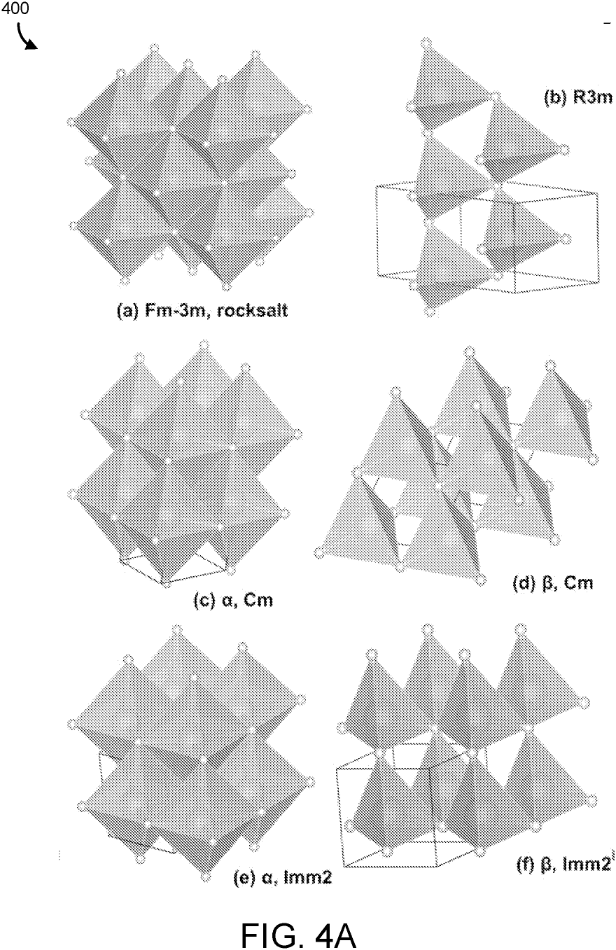

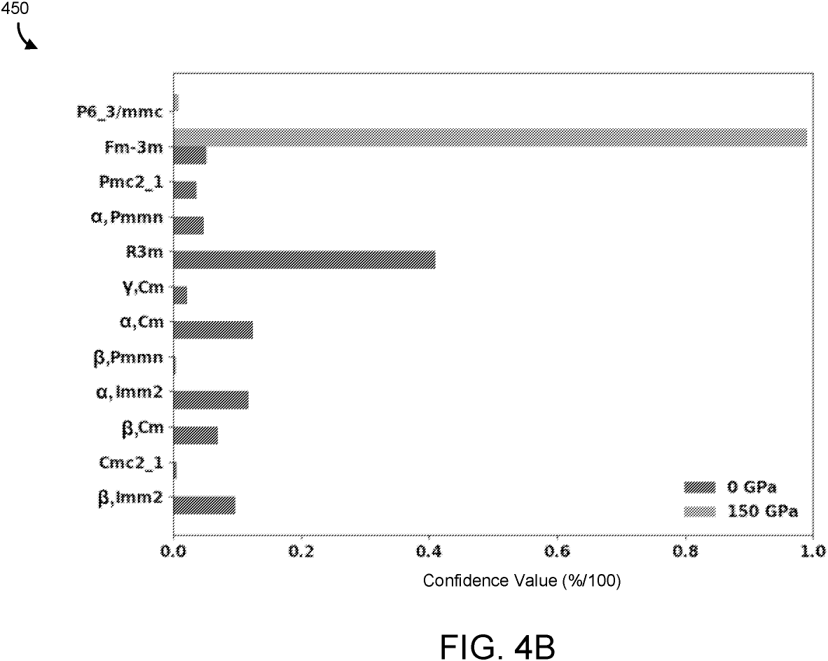

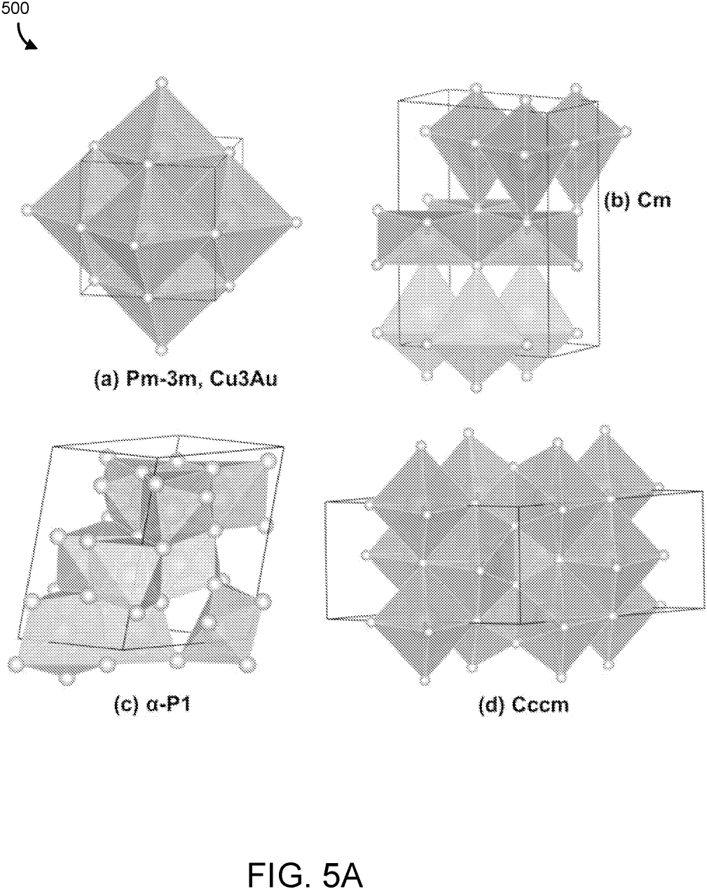

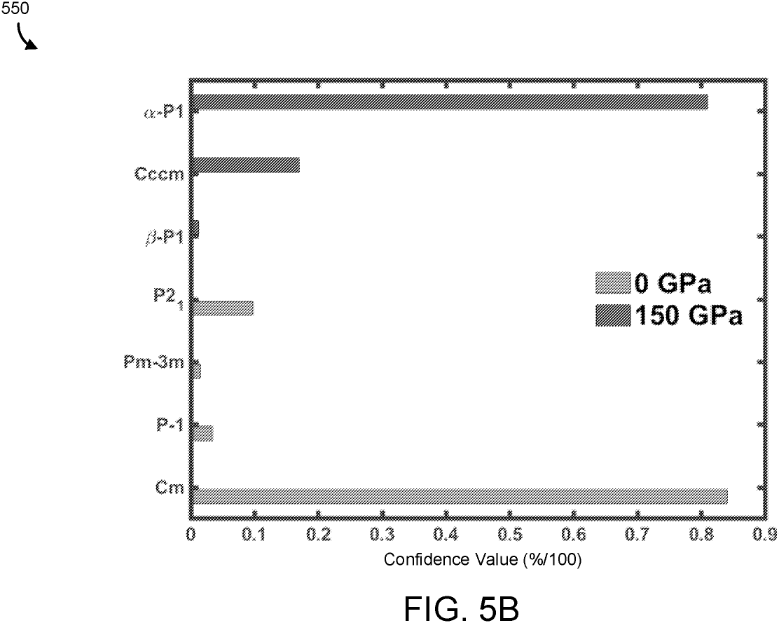

Next, Pd₃H₄ is discussed, which is the only higher hydride reported experimentally at around 5 GPa. A structure search is performed to identify the Cm structure as the most probable with Pd having 5-fold and 6-fold coordination. The model shows that the experimentally observed Cu₃Au-type structure with the Pm-3m space group as one of the probable structures. This structure can be viewed as introducing one Pd vacancy in each unit cell of the rocksalt PdH. It can therefore also be written as Pd₃VaH₄, where Va represents a vacancy. At high pressure, a low-symmetry P1 structure is found with a relatively complex coordination environment as the most probable structure. The results of this modeling process are shown in FIGS. 4A, 4B, 5A, and 5B.

FIG. 4A shows six structure models (collectively models 400), individually labeled (a), (b), (c), (d), (e), and (f). Model (a) of models 400 represents an Fm-3m rocksalt functional structure. Model (b) of models 400 represents an R3m functional structure. Model (c) of models 400 represents an α, Cm functional structure. Model (d) of models 400 represents a β, Cm functional structure. Model (e) of models 400 represents an α, Imm2 functional structure. Model (f) of models 400 represents a β, Imm2 functional structure.

FIG. 4B illustrates a graph 450 representing confidence values (as normalized percentages ranging from 0 (no probability) to 1 (100% probability) for each tested structure including models 400. Results are shown for tests associated with two pressures: 0 gigapascals (GPa) and 100 GPa. As subsequently described, the confidence value (c-value) is used for determining the uncertainty associated with the choice of the functional.

FIG. 5A shows four structure models (collectively models 500), individually labeled (a), (b), (c), and. Model (a) of models 500 represents a Pm-3m, Cu₃Au functional structure. Model (b) of models 500 represents a Cm functional structure. Model (c) of models 500 represents an α-P1 functional structure. Model (d) of models 500 represents a Cccm functional structure. FIG. 5B illustrates a graph 550 representing confidence values (as normalized percentages ranging from 0 (no probability) to 1 (100% probability) for each tested structure including models 500. Results are shown for tests associated with two pressures: 0 gigapascals (GPa) and 100 GPa. As subsequently described, the confidence value (c-value) is used for determining the uncertainty associated with the choice of the functional. These results are subsequently described in greater detail.

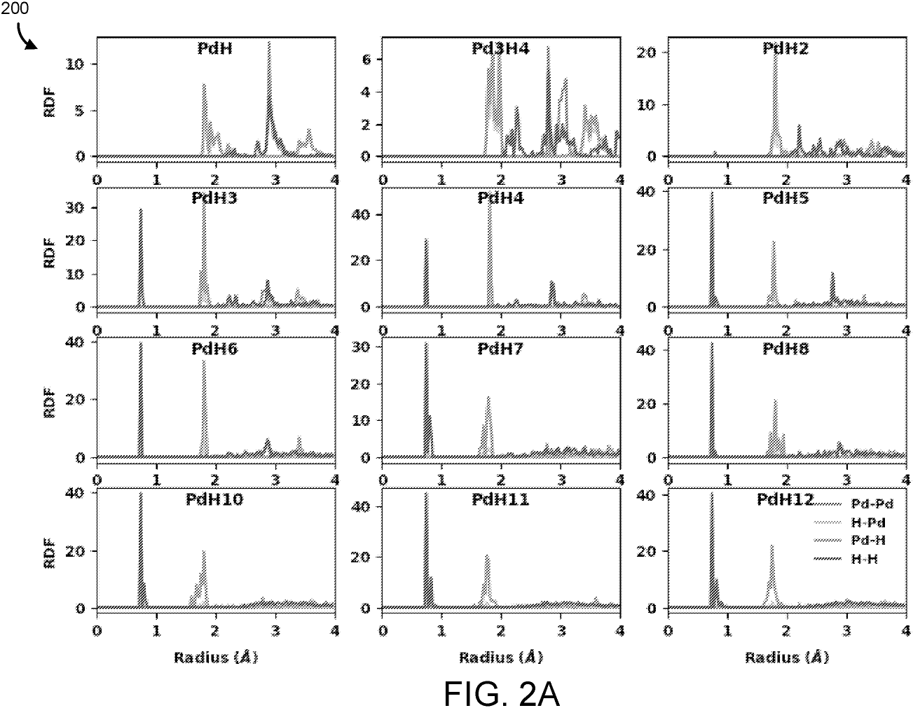

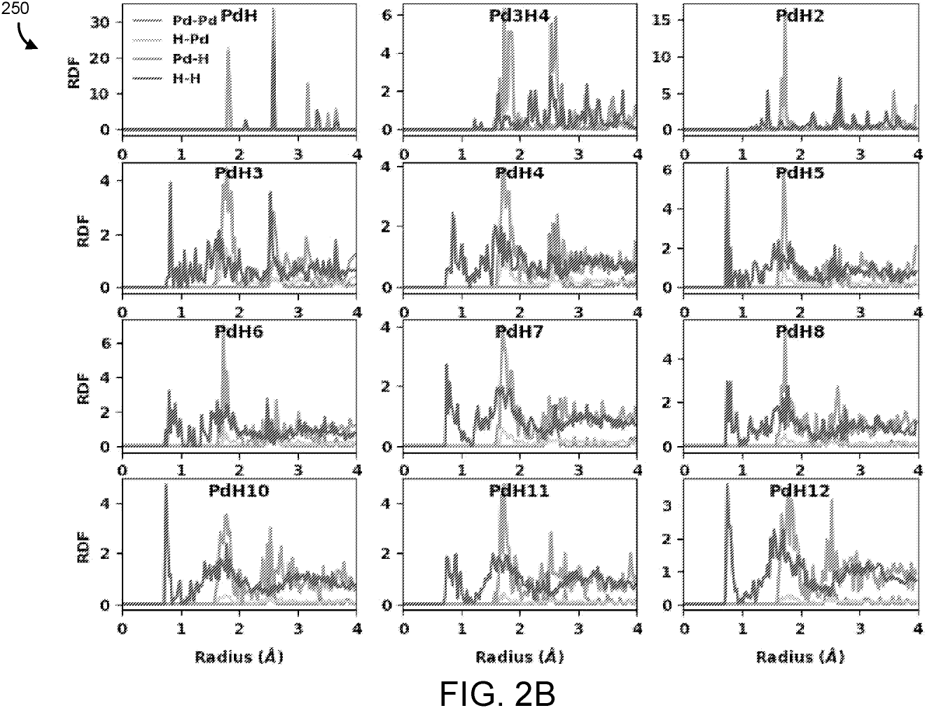

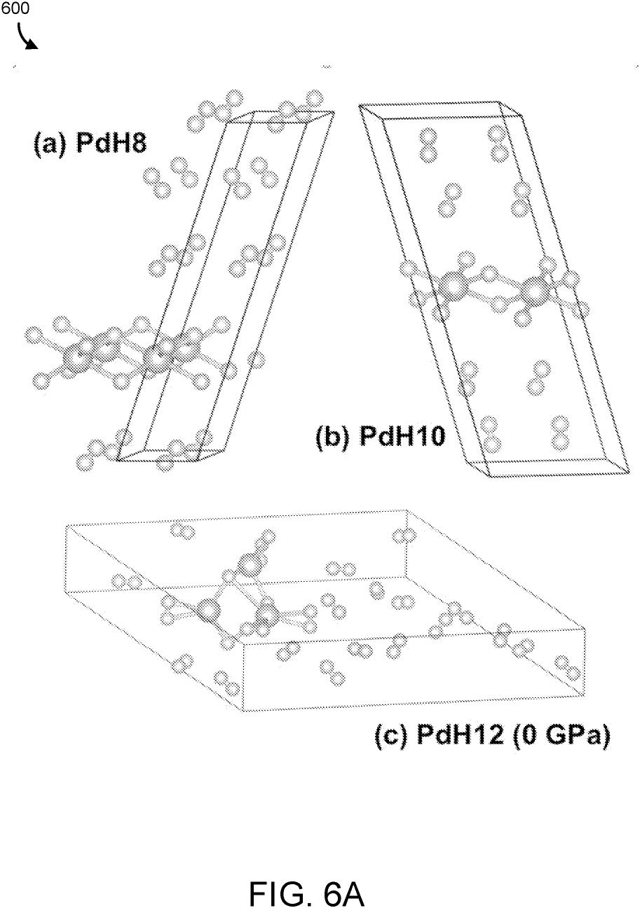

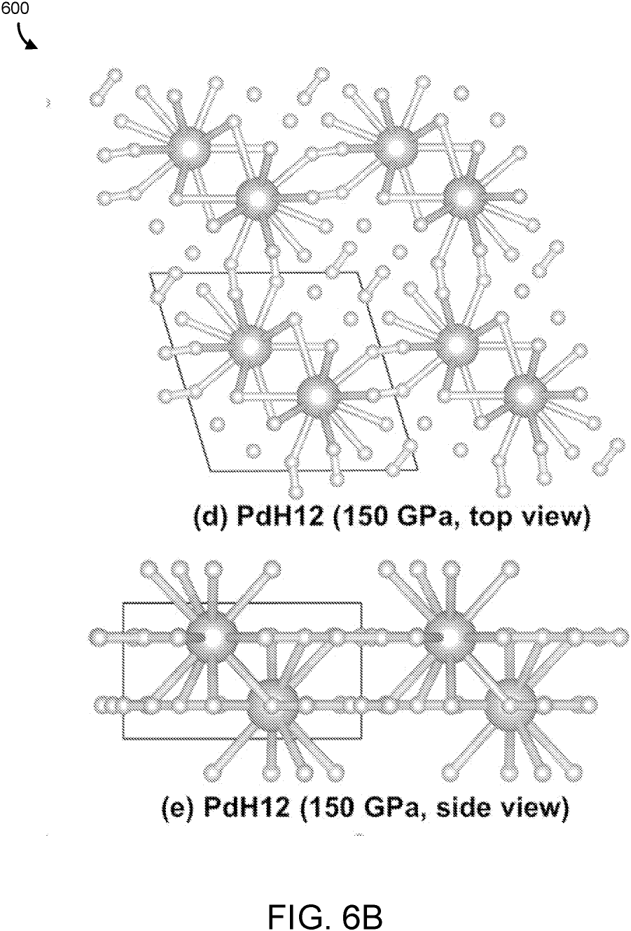

Once the low-symmetry P1 structure is found, the model is configured to search over the stable structures for compositions, PdHₙ where n is an integer between 2 and 12. Some of the most probable structures are identified in FIGS. 6A and 6B. They consist of Pd—H layers or clusters separated by H₂ molecules, indicating that extra H atoms cannot form strong chemical bonding with Pd under ambient pressure. To characterize their coordination features, the average Radial Distribution Function (RDF) of low enthalpy structures of all the studied compositions under 0 GPa and 150 GPa are plotted in graphs 200, 250 of FIGS. 2A and 2B, respectively. Under 0 GPa, the dominant coordination is Pd—H and H—H. While Pd—H is relatively unchanged within 1.7-2.0 Å, which corresponding to Pd—H bonds, H—H changes significantly with composition. For PdHn, when n is smaller than 2-3, H—H is mainly beyond 2 Å, but when n is larger than 2-3, H—H forms a peak at about 0.7-0.8 Å, corresponding the bond length of H2, indicating the formation of H2 molecules. Pressure also affects RDF significantly. Under 150 GPa, a major difference is that H—H spans the whole range beyond H₂ bond length, indicating diverse coordination environments of H under high pressure.

For the structure search model, some the following example embodiments were applied. The particle swarm optimization is employed for structure search, using the CALYPSO code. Since only the superhydrides are of interests here, the compositions PdHₙ (n is an integer and 1 <= n <= 12) and Pd₃H₄ which is the highest Pd hydride reported in experiments so far, totaling 13 compositions in all. For each composition, one unit cell is allowed to have 1-4 formulas. For a fixed number of formula under a given composition, about 1000 structures were searched during the structure evolution.

For the Bayesian Error Estimation Functional, for each material, a collection of functionals at the level of the generalized gradient approximation (GGA) were used as described below. For the purpose of error estimation, the Bayesian error estimation functional with van der Waals correction was used. Besides acting in the usual manner for the self-consistent calculation of the exchange correlation energy, this empirically fit functional can generate an ensemble of functionals that are small perturbations away from the main functional fit in exchange correlation space. The exchange-correlation energy for the BEEF-vdW is given as:

$$\begin{matrix}{E}_{X C} = {\sum }_{m} {a}_{m} \int {ε}_{x}^{U E G} \left(n\right) {B}_{m} \left[t \left(s\right)\right] d r + {a}_{c} {E}^{L D A - c} \\ + \left(1 - {a}_{c}\right) {E}^{P B E - c} + {E}^{n l - c}\end{matrix}$$

Here Bₘ is the m^{th} Legendre basis function, each of which has a corresponding expansion coefficient aₘ. The expansion coefficients, as well as the α_{c} parameter that mixes the local density approximation (LDA) and PBE exchange correlation functionals, have been pre-fit with respect to a range of data sets as described in Wellendorff, et al., Density functionals for surface science: Exchange-correlation model development with Bayesian error estimation. Phys. Rev. B 85, 235149 (2012), which is incorporated by reference in entirety herein. Additionally within the functional is the E^{n1-c} nonlocal correlation term implemented via the vdW-DF2 method. The method to generate the ensemble of functionals was tuned such that the spread of the predictions of the functionals matches the error of the main self-consistent functional with respect to the training and experimental data on which it was originally trained. Each of these functionals can then provide a non-self-consistent prediction of energy and therefore allows for a computationally efficient yet systematic way of understanding the sensitivity of the final prediction with respect to small changes in exchange correlation functional.

Confidence-value (c-value) Calculations: The confidence value (c-value) is used for determining the uncertainty associated with the choice of the functional. The c-value is the fraction of the ensemble that predict a certain structure to be the ground state. For a fixed composition, this simply involves counting the fraction of functionals that predict a particular structure to be the ground state. This framework can be expanded to construct a c-value associated with a Pourbaix diagram. In this case, the c(U; pH), for a specific phase is defined as the fraction of functionals that predict it to have the lowest free energy at a given potential and pH, given by

$${c}_{i} \left(U , p H\right) = \frac{1}{{N}_{e n s}} {\sum }_{n = 1}^{{N}_{e n s}} {\prod }_{j \neq i} \text{Θ} \left(Δ {G}_{j}^{n} \left(U , p H\right)\right) - Δ {G}_{i}^{n} \left(U , \left(p H\right)\right)$$

where the summation is over number of ensembles, Nₑₙₛ = 2000, and the product is over all the remaining possible phases. Θ(x) denotes the Heaviside step function. At any given U and pH, i;j ∈ S, the set of all considered phases.

For the topological analysis, the coordination number is determined using the CrystalNN class based on a Voronoi algorithm in pymatgen. The framework of the crystal structure and its dimensionality are identified using the Zeo++ code based on the Voronoi decomposition, where radii of 0.5 Å and 1.6 Å are adopted for H and Pd respectively.

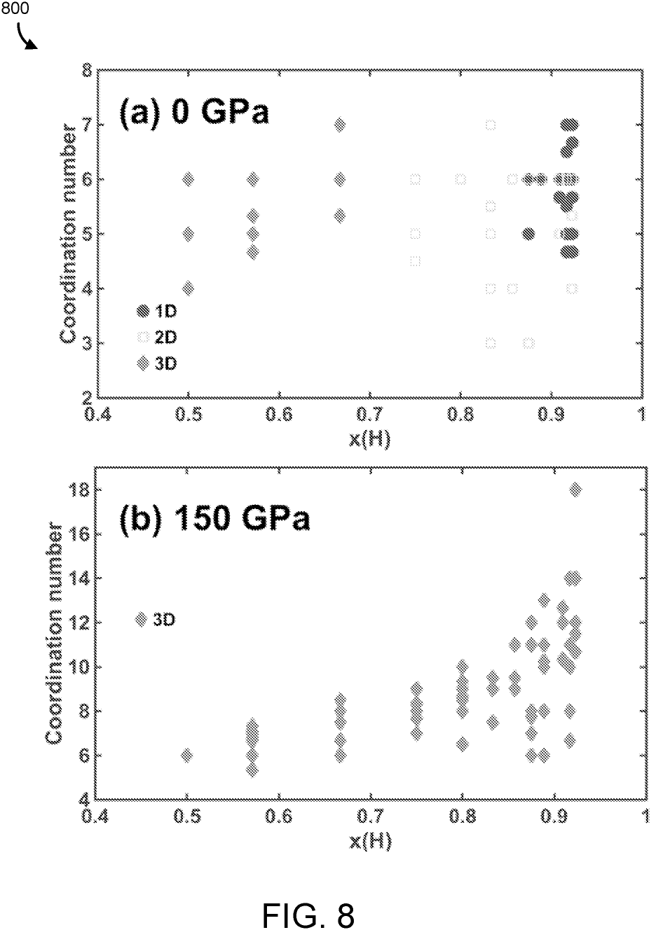

To gain a better overall insights of the obtained structures, a topological analysis was made for low enthalpy structures, with results briefed in graphs 800 of FIG. 8. Graph (a) of graphs 800 shows composition-dependent topological features of the low enthalpy structures under 0 GPa of palladium hydrogen. Graph (b) of graphs 800 shows composition-dependent topological features of the low enthalpy structures under 150 GPa of palladium hydrogen. The coordination number describes the number of H atoms coordinated to Pd, and the dimensionality is used to describe the framework formed by the Pd polyhedrons

Each structure is based on a Pd—H framework with the void space occupied by extra H atoms if any, which are mainly present in the form of H2 molecules. The basic structural unit in the Pd—H framework is the polyhedron where the centering Pd atom is coordinated with neighboring H atoms. The Pd-centered polyhedrons can be directly connected with each in terms of sharing of faces, edges or corners, or indirectly connected via intermediate H atoms, forming a network with some dimensionality. In a 0D framework, the Pd-centered polyhedrons are isolated, while they form columns and layers in 1D and 2D frameworks respectively. In a 3D framework, the network extends in all the three dimensions continuously. Both pressure and composition have significant influence on the coordination number of Pd (CN) and dimensionality of the Pd-H framework. Under 0 GPa, CN is be- tween 3 and 7, and has a moderate trend of increase from PdH to PdH₂but the increase is saturated in overall beyond PdH₂, with the maximum CN pinned at 7. The dimensionality also changes around PdH₂ and the transition is even sharper. From PdH to PdH₂, the frameworks are exclusively 3D, while beyond PdH₂, no 3D framework is present in the studied structures. From PdH₃ to PdH₆, the frameworks are exclusively 2D, while starting from PdH₇, 1D becomes dominant gradually. Under 150 GPa, the frameworks are invariably 3D regardless of the compositions, but CN becomes more diverse, spanning between 5.33 and 18, and shows a drastic increase with the composition. Based on the above analysis, it can be concluded that high pressure can compress large amount of H around Pd and increase the connectivity of the frameworks of Pd superhydrides which are otherwise quite loose under ambient pressure. Furthermore, since it is already shown that any Pd superhydride under the studied pressure is thermodynamically unstable against PdH and H₂, high pressure seems necessity in that it can generate the 3D framework with possibility to keep lattice integrity after H2 molecules escape from the framework.

The most probable stable structure of PdH₁₂ under 150 GPa is monoclinic and has the Cmcm space group, shown in FIGS. 6A and 6B. In FIGS. 6A-6B, five structures are shown (collectively structures 600). Structure (a) of structures 600 is a PdHs structure. Structure (b) of structures 600 is a PdH₁₀ structure. Structure (c) of structures 600 is a PdH₁₂ structure at 0 GPa. In FIG. 6B, structure (d) of structures 600 is a PdH₁₂ structure at 150 GPa from a top view. Structure (e) of structures 600 is a PdH₁₂ structure from a side view. The PdH₁₂ structure is distinct from those predicted as thermodynamically stable phases for rare-earth superhydrides, which are based on clathrate or cage-like structures. PdH₁₂ Cmcm structure consists of a 3D network of Pd-centered H cages bridged by H—H covalent bonds with the space in-between filled with H2 molecules. Interestingly, viewing perpendicular to the monoclinic c axis, all the H atoms are arranged in 2D layers, which are stacked together along the c axis.

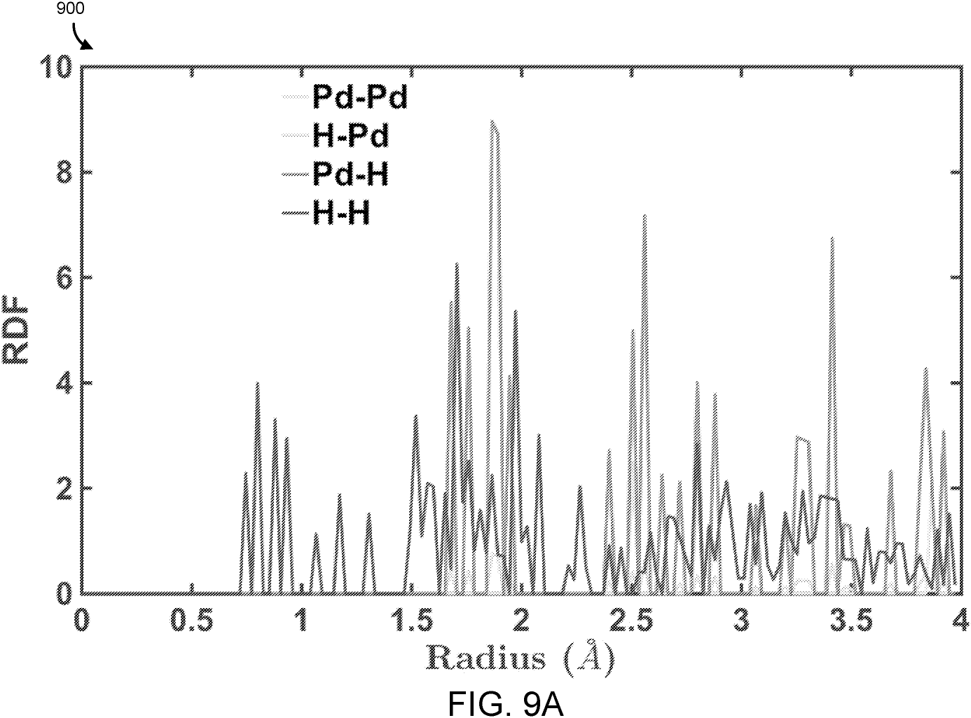

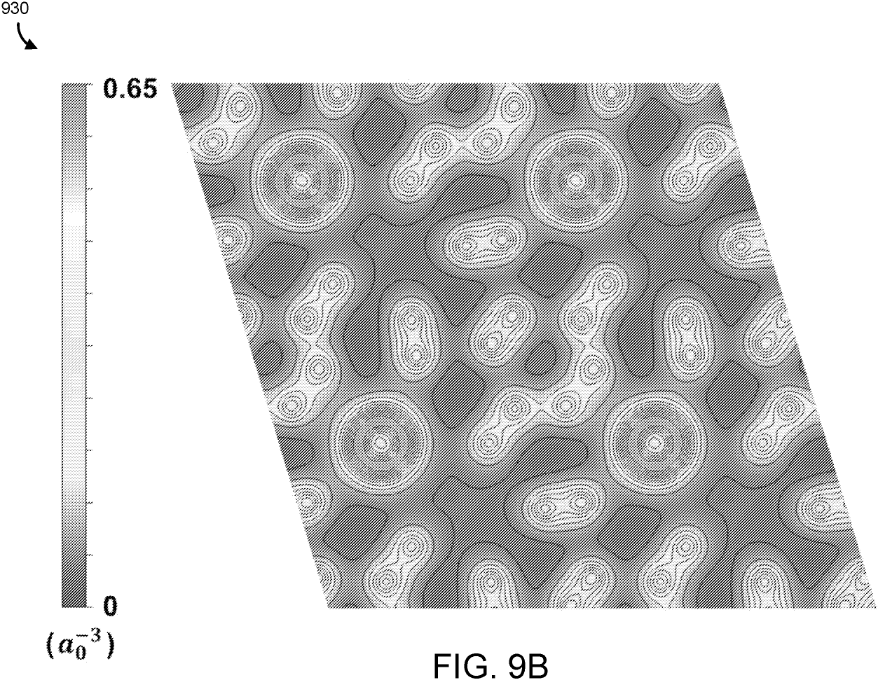

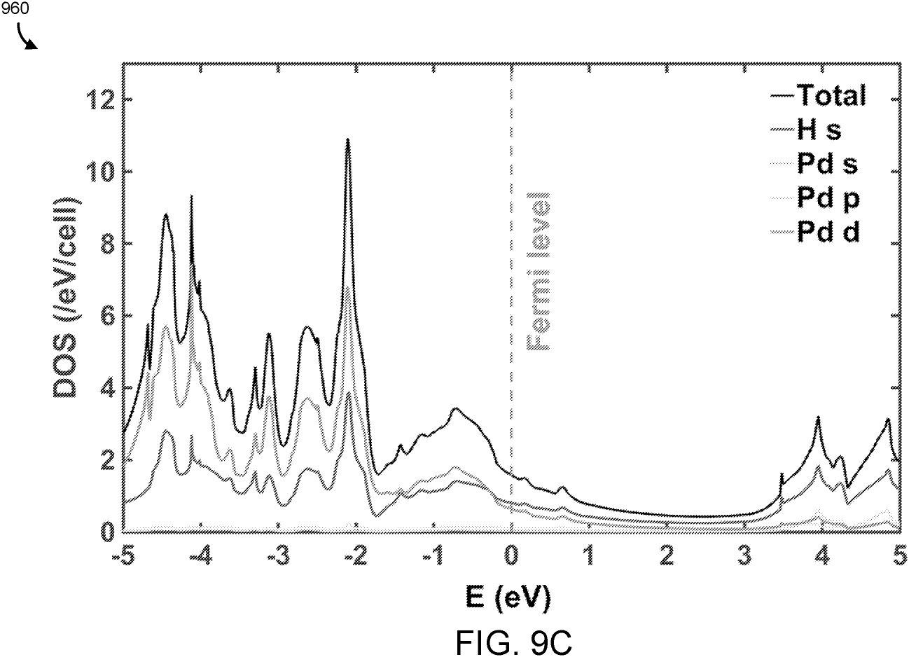

FIG. 9A shows a graph 900 illustrating radial distribution functions (RDFs) for structures Pd—Pd, H—Pd, Pd—H, and H—H. Primary Pd—H bonding is within a narrow region, about 1.7-1.9 Å, corresponding to the distance between the centered Pd and the H of the cages, while H—H bonding is much more widespread and consist of two groups, 0.7-1.0 Å corresponding to H2 molecules between cages and the bridging H₂ dimers connecting cages, and 1.5-2.0 Å corresponding to the neighboring H atoms within the same cage surface. The charge density distribution of a (001) plane is plotted in diagram 930 of FIG. 9B. The charge density between H—H is higher than that between Pd—H, indicating that covalent H—H bonds are dominant over Pd—H bonds, even under a high pressure of 150 GPa. This can be understood by noting that the electro-negativities of Pd and H are very close with each other, and the charge transfer is insignificant even under a large compression. Still, weak bonding forms between Pd and H. The electronic density of states (DOS) is shown in graph 960 of FIG. 9C, where the total DOS is decomposed to contributions from different orbitals, H-s, Pd-s, Pd-p and Pd-d. The considerable DOS at the Fermi level indicates that the monoclinic PdH₁₂ under 150 GPa is a metal, similar to the solid metallic hydrogen under high pressure. The dominant partial DOS are from H-s and Pd-d showing strong hybridization, both contributing to conducting electrons.

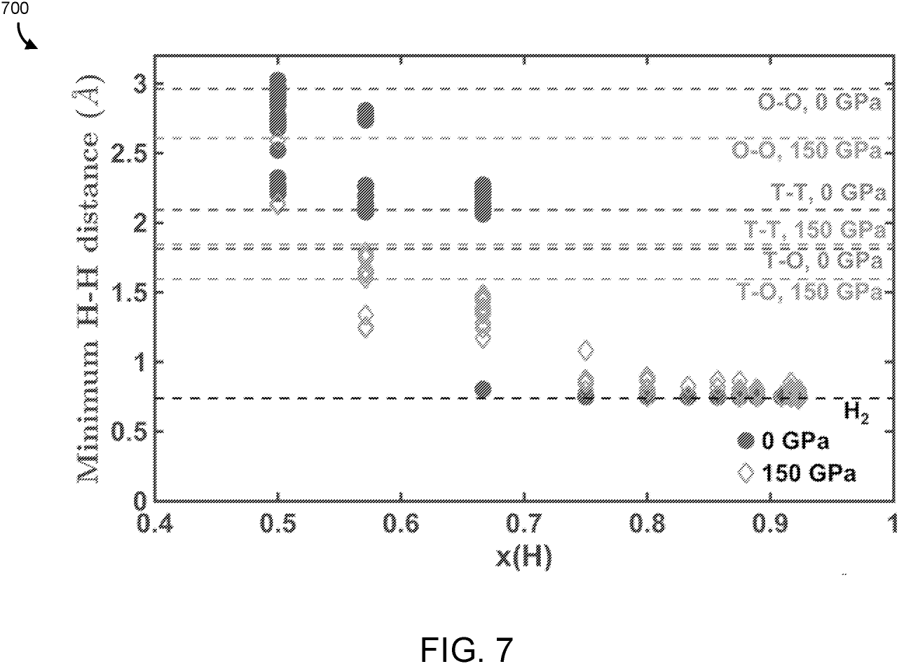

FIG. 7 shows a graph 700 illustrating a distribution of the minimum H-H distances of the low enthalpy structures under 0 GPa and 150 GPa. The black dashed line represents the H—H distance in H2 molecule, 0.74 Å. The H—H distances for the rare-earth superhydrides are in the range of 1.1 Å at high pressure, in violation of the so- called Switendick criteria for the minimum H—H distances of 2.1 Å in common hydrides. Recently, evidence for H—H distances below 1.6 Å was found in ZrV₂Hx, even at ambient pressure, from inelastic neutron scattering. In order to analyze how the H—H distance changes with composition and pressure, the distribution of minimum H—H distances of the low enthalpy structures under 0 GPa and 150 GPa is plotted in FIG. 7. The composition has a large influence on the minimum H—H distance. Under 0 GPa, the minimum H—H distance is around 1.8-2.1 Å for PdH, but drastically drops to about 0.8 Å for PdH₂, close to the H—H distance in H₂ molecule, 0.74 Å. Further increasing H content does not cause significant changes, and the minimum H—H distance is pinned by the H—H distance in H₂ molecule. A similar trend holds for 150 GPa, though the minimum H—H distance usually shrinks compared with that under 0 GPa, due to large compression exerted by the high pressure. However, the H—H distance is pinned to the H₂ molecule even at 150 GPa.

Having identified the possible stable structures, the phase stability is assessed with an enthalpy convex hull. Using an ensemble of functionals, an ensemble of convex hulls is generated, which are shown in SI. No Pd superhydrides are thermodynamically stable at 0 GPa. Under 150 GPa, there are still no thermodynamically stable superhydrides, although PdH₁₂ is only slightly unstable. However, it is worth noting that the stability of superhydrides is greatly increased compared to the case under ambient pressure.

While high pressure has been explored extensively to stabilize metal superhydrides, using electrochemistry to stabilize metal superhydrides has not been previously shown. Here, an alternate approach to synthesizing metal superhydrides is shown. In this approach, an electrode consisting of a metal (or conducting metal hydride) can be loaded with hydrogen by holding at an appropriate electrode potential using an electrolyte consisting of mobile protons. The proton-conducting membrane could be an aqueous electrolyte solution, polymer electrolyte membrane (e.g. Nafion), proton-conducting ceramic electrolytes, and solid acid proton conductors. The electrolytes provide a way to tune the activity of mobile protons and kinetics of reactions at electrode-electrolyte interfaces.

The hydrogen loading reaction for a metal electrode and an electrolyte including mobile protons is given by:

$$\text{Pd} + \text{n} \left({\text{H}}^{+} + {\text{e}}^{-}\right) ⇔ {\text{PdH}}_{\text{n}}$$

with the associated Gibbs Free Energy of the reaction:

$$Δ \text{G} = {\text{G}}_{{\text{PdH}}_{\text{n}}} - {\text{G}}_{\text{Pd}} - {\text{nG}}_{{\text{H}}^{+}} - {\text{nG}}_{{\text{e}}^{-}} .$$

The free energy of protons at unit activity and electrons at electrode potential zero on the standard hydrogen electrode scale can be related to the free energy of hydrogen gas. Then, thermodynamic corrections can be added to account for the effect of electrode potential and activity of protons. The computational hydrogen electrode equation provides the relation,

$${\text{G}}_{{\text{H}}^{+} \left({\text{a}}_{\text{H}}^{+} = 1\right)} + {\text{G}}_{{\text{e}}^{-} \left(\text{U} = 0\right)} = \frac{1}{2} {\text{G}}_{{\text{H}}_{2}} .$$

This provides the relation,

$$Δ \text{G} = {\text{G}}_{{\text{PdH}}_{\text{n}}} - {\text{G}}_{\text{Pd}} - \frac{\text{n}}{2} {\text{G}}_{{\text{H}}_{2}} + {\text{neU}}_{\text{SHE}} - {\text{nk}}_{\text{B}} \text{T} ln \left({\text{a}}_{{\text{H}}^{+}}\right) .$$

This relation allows an electrochemical phase diagram for loading hydrogen into a material as a function of pH of the electrolyte and the electrode potential to be constructed. Lowering the electrode potential (e.g., making it more negative) or increasing the activity of protons enables loading higher amounts of hydrogen. However, in a practical device, at negative potentials, metals tend to catalyze the hydrogen evolution reaction, given by:

$$2 {\text{H}}^{+} + 2 {\text{e}}^{-} ⇔ {\text{H}}_{2} .$$

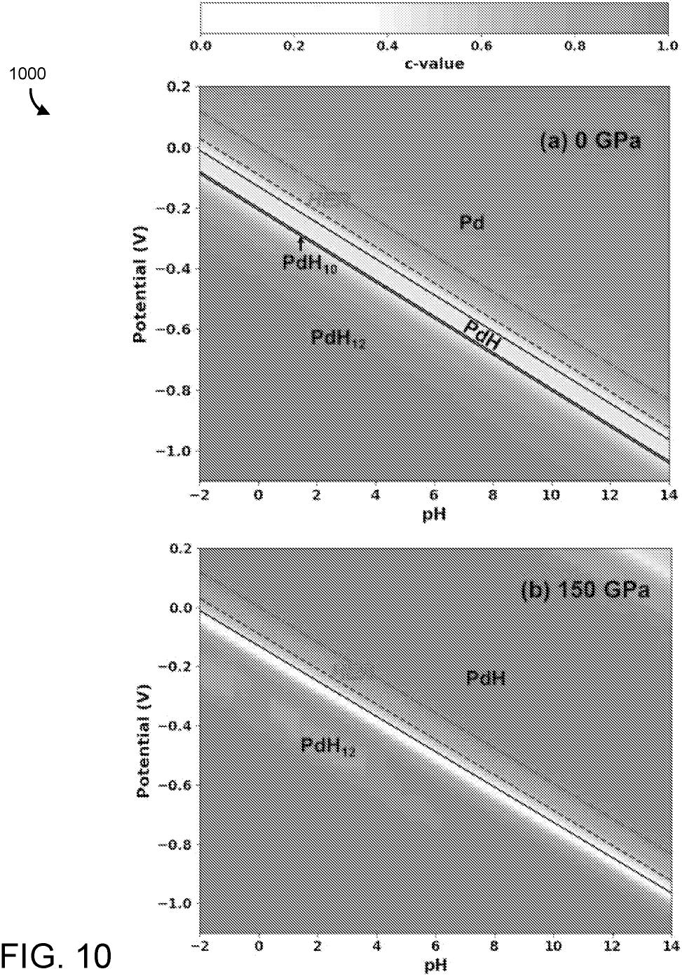

Hence, electrochemical loading needs to be done in electrolyte formulations that can suppress the hydrogen evolution reaction kinetically through super concentrated electrolytes or other sup- pressing mechanisms. The electrochemical phase diagram 1000 incorporating uncertainty analysis at ambient pressure is shown in FIG. 10.

At ambient pressure, at pH = 0, (a_{H}+ = 1), the electrochemical loading of even the PdH phase will be challenging and will compete with the hydrogen evolution reaction. Typically, Pd catalyzes hydrogen evolution with almost no over-potential, thus suppressing hydrogen evolution will be important and challenging. Further, it is likely that the bulk loading reaction will have slower kinetics than surface catalyzed hydrogen evolution reaction making this even more challenging.

High-pressure electrochemistry has been little explored, but there have been some attempts at modest pressures. Here, both high-pressure and electrochemistry are combined to understand the electrochemical phase diagram at 150 GPa, which is shown in FIG. 10. It is possible to load several superhydride phases around the potentials for hydrogen evolution reaction.

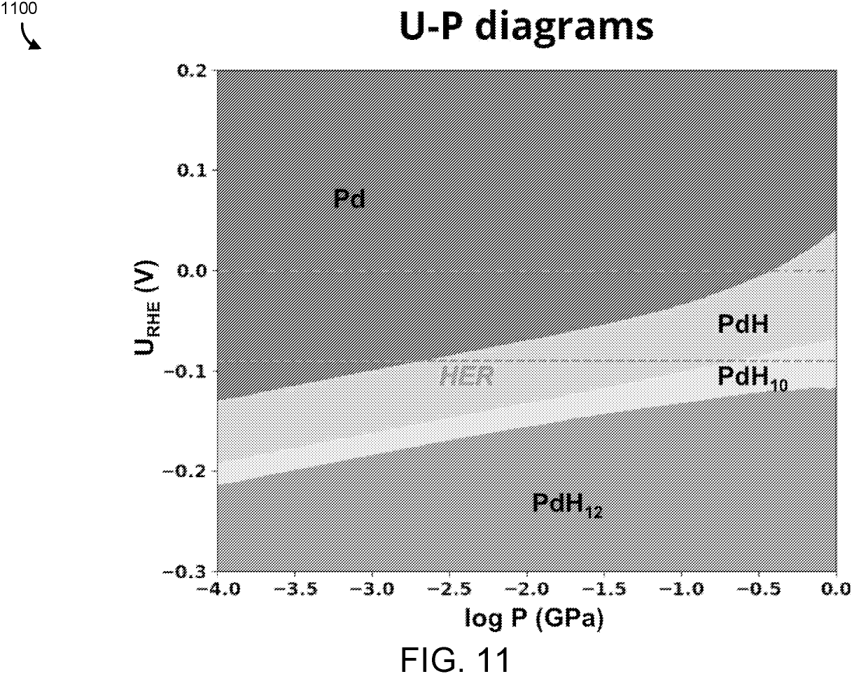

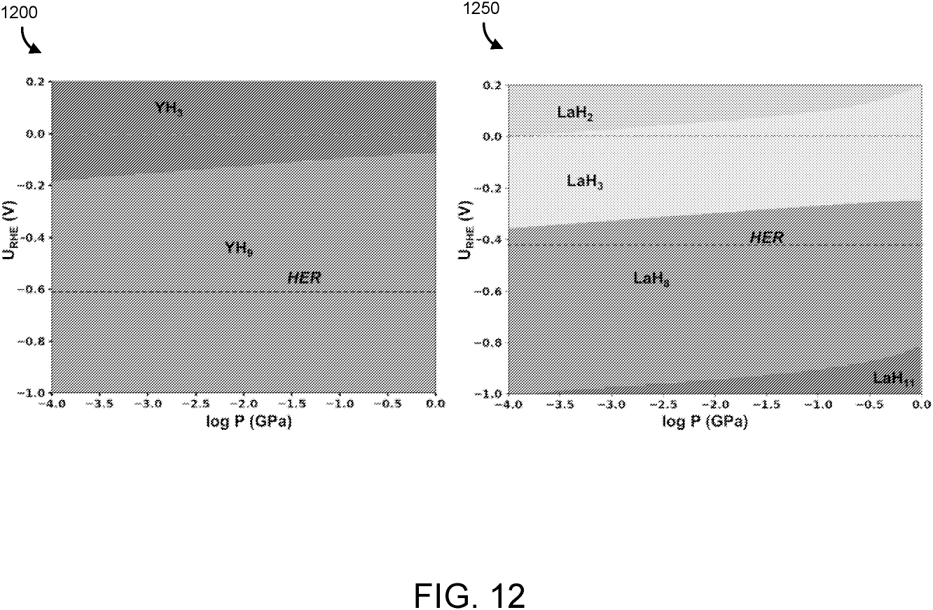

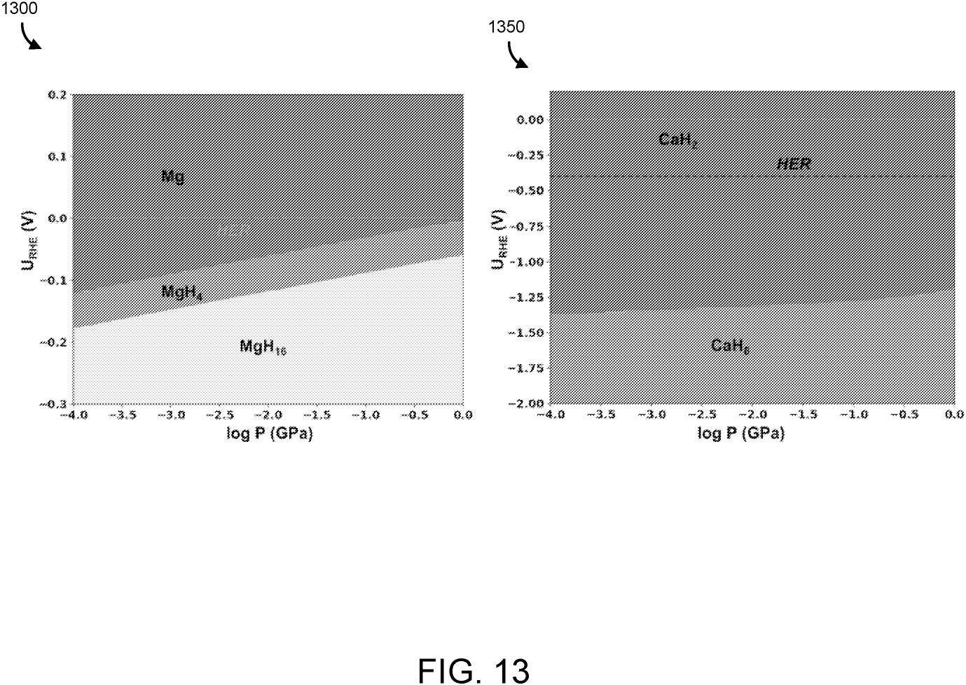

Additional metal superhydrides are possible, as shown by U-P diagrams 1100, 1200 and 1250, and 1300 and 1350 of FIGS. 11, 12, and 13, respectively. For example, U-P diagram 1100 of FIG. 11 shows that PdH can be synthesized under 200 MPa. UP diagram 1200 of FIG. 12 shows that YH₉ can be synthesized at ~1 MPa and -0.2 V, and U-P diagram 1250 shows that LaHs can be synthesized around 1 GPa and -0.3 V. The lower dashed line represents the HER potential (as labeled in graphs 1200 and 1250) with overpotential considered. Graph 1300 of FIG. 13 shows that MgH₁₆ can be synthesized around 100 MPa, and graph 1350 shows that -0.2 V and that CaH₆ could also be synthesized. In graphs 1300 and 1350 of FIG. 13, the lower dashed line represents the HER potential (as labeled in each of graphs 1300 and 1350) with overpotential considered. For Mg, the HER line is the same as the equilibrium HER potential.

In addition to the results previously described, ternary superhydrides can be developed as now described. P² strategy combines electrochemistry and pressure for the following loading reaction:

$$\text{xLi} + \text{yMg} + \text{z} \left({\text{H}}^{+} + {\text{e}}^{-}\right) ⇌ {\text{Li}}_{\text{x}} {\text{Mg}}_{\text{y}} {\text{H}}_{\text{z}}$$

Equation [5] is combined with the computational hydrogen electrode equation, which provides the following free energy relation: ΔG_{H}+ + ΔGₑ-,_{URHE}= 0 = AG_{H2}(_{g}). Negative electrode potentials, U_{RHE} < 0, provide driving force for increasing hydrogenation, but also suppress the competing hydrogen evolution reaction.

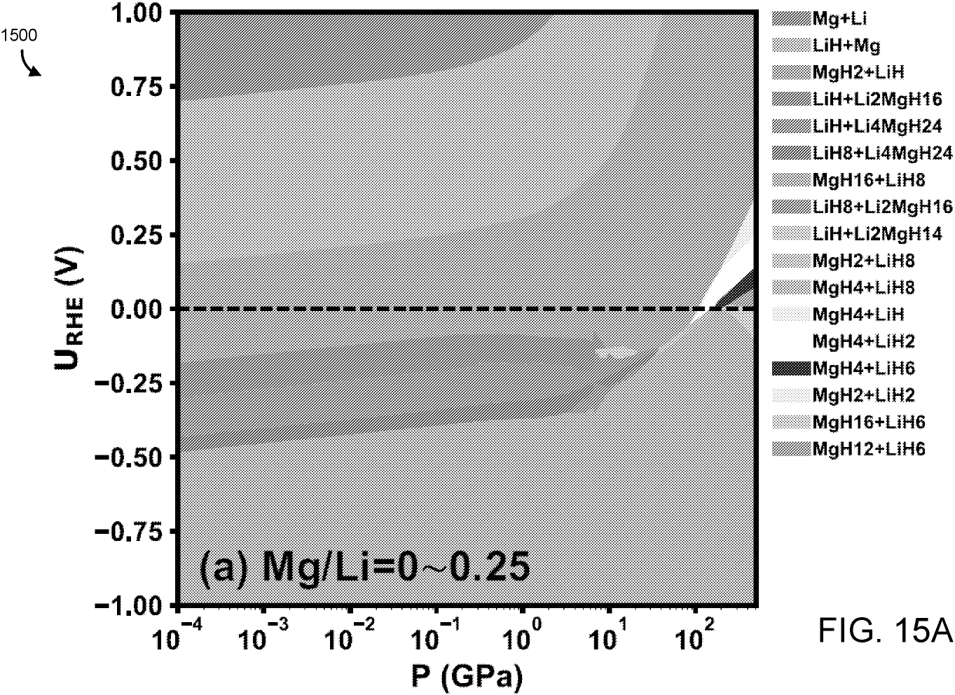

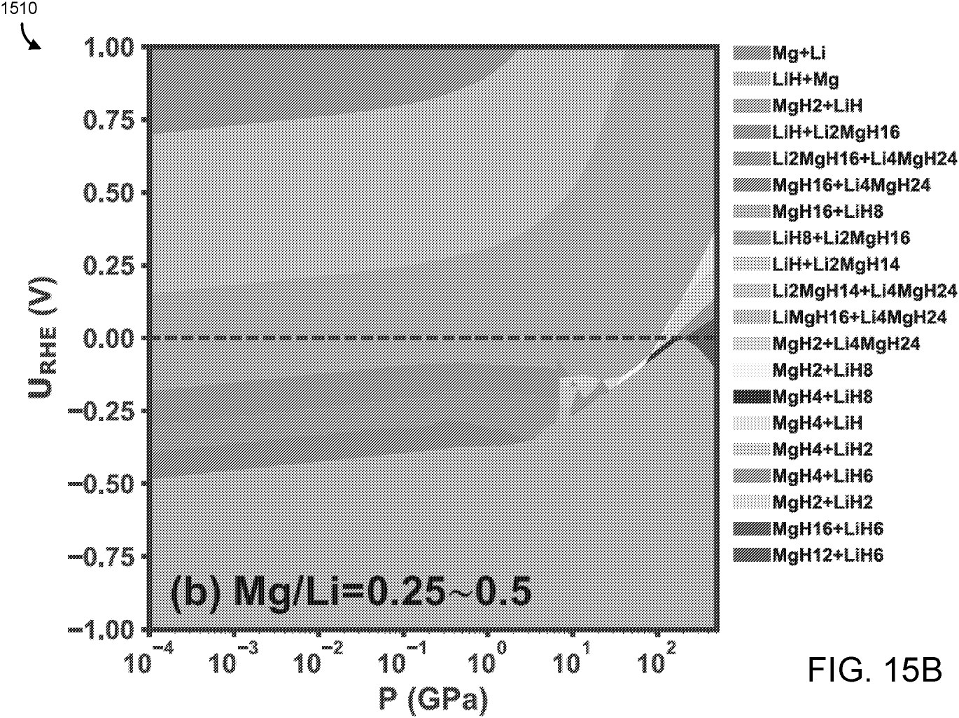

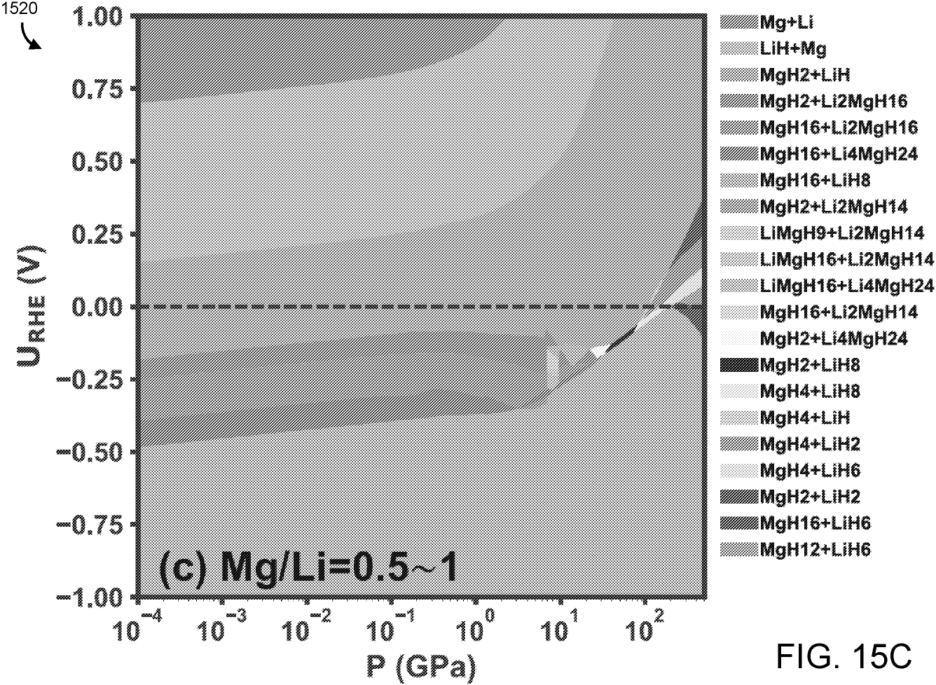

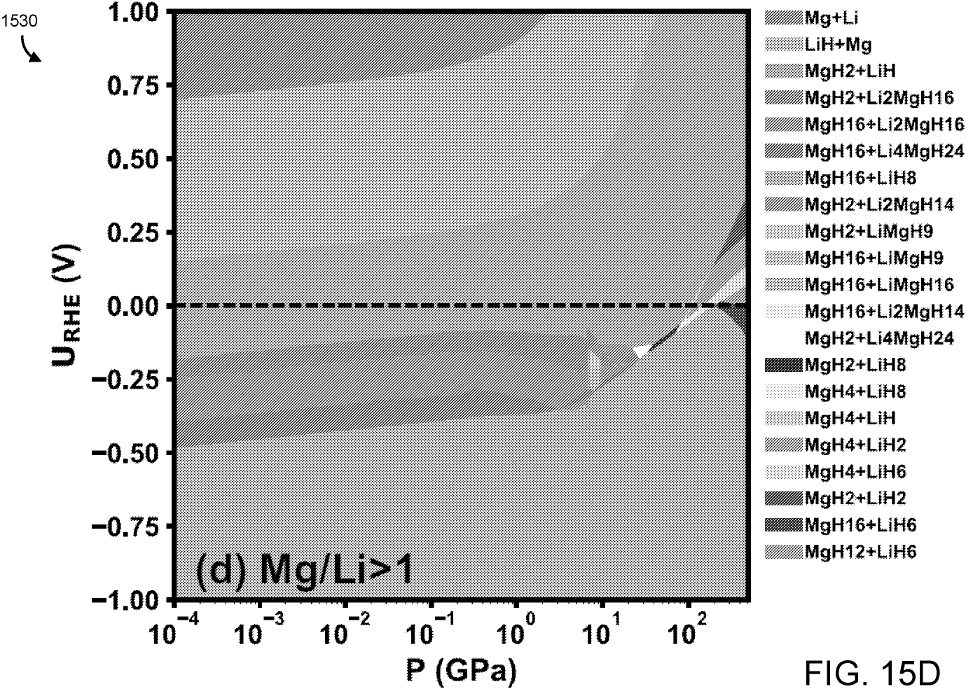

The pressure dependent Pourbaix diagram of Li—Mg—H by the best-fit BEEF-vdW functional at 300 K is shown in graphs 1500, 1510, 1520, and 1530 of FIGS. 15A-15D, respectively. All the phases are considered stoichiometric. Besides the pure substances, a total of 36 compositions are considered, including 9 binaries and 27 ternaries as listed in Table 1.

TABLE 1

Compositions considered in the thermodynamic analysis for the Li—Mg—H system.

| | |
|---|---|
| Systems | Compositions considered |
| Li—H | LiH, LiH₂, LiH₆, LiHs |
| Mg—H | MgH₂, MgH4, MgH₆, MgH₁₂, MgH₁₆ |
| Li—Mg—H | LiMg₂H₁₀, LiMg₂H₁₂, LiMg₂H₁₄, LiMg₂H₁₆, LiMgH₃, LiMgHs, LiMgH₆, LiMgH₇, LiMgH_{8,} LiMgH₉, LiMgH₁₀, LiMgH₁₂, LiMgH₁₄, LiMgH₁₆, Li₄Mg₃H₂₄, Li₅Mg₃H₂₄, Li₂MgH₄, Li₂MgHio, Li₂MgH₁₂, Li₂MgH₁₄, Li₂MgH₁₆, Li₃MgH₁₂, Li₃MgH₁₄, Li₃MgH₁₆, Li₄MgH₁₆, Li₄MgH₂₄, Li₅MgH_{I6} |

The phase equilibria depend on the Li/Mg ratio. At zero potential, U_{RHE} = 0, for any Li/Mg ratio, no ternary Li—Mg hydrides are thermodynamically stable within the studied range of conditions. The phase equilibria is MgH₂+LiH from ambient pressures to ~100 GPa, above which a transition sequence MgH₄ +LiH → MgH₄ + LiH₂ → MgH4 + LiHs → MgH₄ + LiH₆ → MgH₁₆ + LiH₆ → MgH₁₂ + LiH₆ occurs. Applying positive potential, U_{RHE} > 0, Mg/Li metals, Mg + LiH and MgH₂ +LiH₂ may be stabilized. Applying negative potential, U_{RHE} <0, ternary Li—Mg superhydrides are stabilized at ambient and modest pressures. For Li/Mg ratio 0-0.25, LiH+Li₂MgH₁₆, LiH + Li₄MgH₂₄, and LiH₈+Li₄MgH₂₄ can be accessed with gradually lowered potential. For Li/Mg ratio 0.25-0.5, the accessible phase equilibria become LiH + Li₂MgH₁₆, Li₂MgH₁₆ + Li₄MgH₂₄, and MgH₁₆ + Li₄MgH₂₄. For Li/Mg ratio above 0.5, the accessible phase equilibria are predicted to be MgH₂ + Li₂MgH₁₆, MgH₁₆ + Li₂MgH₁₆, and MgH₁₆ + Li₄MgH₂₄. Among the multiple ternary compositions described, Li₂MgH₁₆ and Li₄MgH₂₄ are the only two that can be thermodynamically favorable at modest conditions, and their stability regions can be maximized under Mg-rich and Li-rich conditions, respectively.

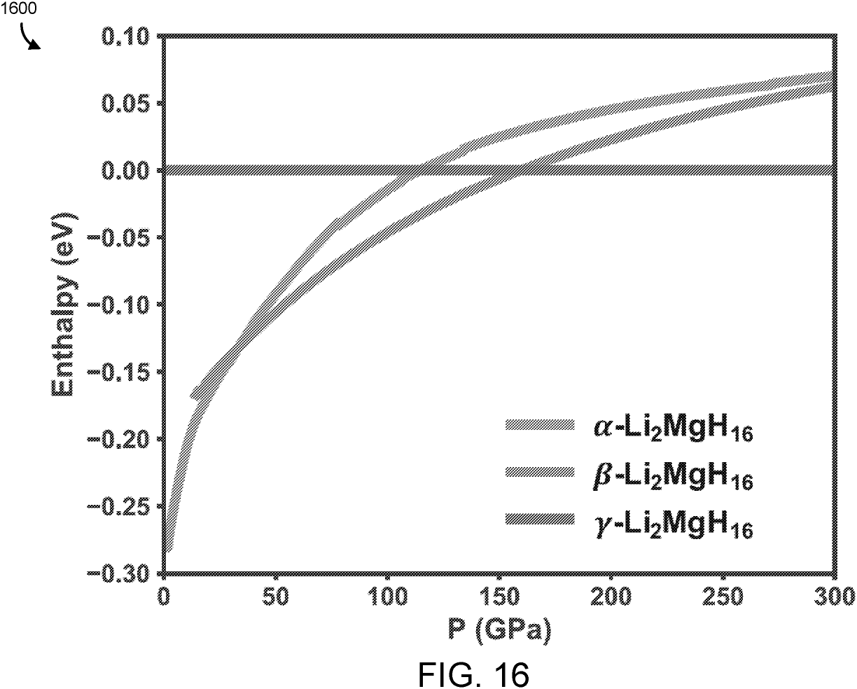

In FIGS. 15A-15D, a ground state at the corresponding pressure is shown for each composition, which has the lowest enthalpy among all the polymorphs. Thus, even with the same stoichiometry, the crystal structure may change at varying pressures, which is shown for Li₂MgH₁₆ in FIG. 16. Li₂MgH₁₆ has three polymorphs up to 300 GPa, which are termed as α, β and γ phases, respectively. The γ phase is predicted as a high-temperature superconductor with T_{c} of ~473 K at 250 GPa. Li₂MgH₁₆ undergoes two polymorphic transitions, α → β at 33 GPa and β → γ at 160 GPa. In addition, based on FIGS. 15A-15D, only α-Li₂MgH₁₆ can be thermodynamically stabilized, provided HER is suppressed. While β-Li2MgH₁₆ and γ-Li₂MgH₁₆ are both unfavorable, it may be still possible to synthesize them as the decomposition into hydrides with different stoichiometries is a diffusional phase transformation requiring enough time and temperature to occur.

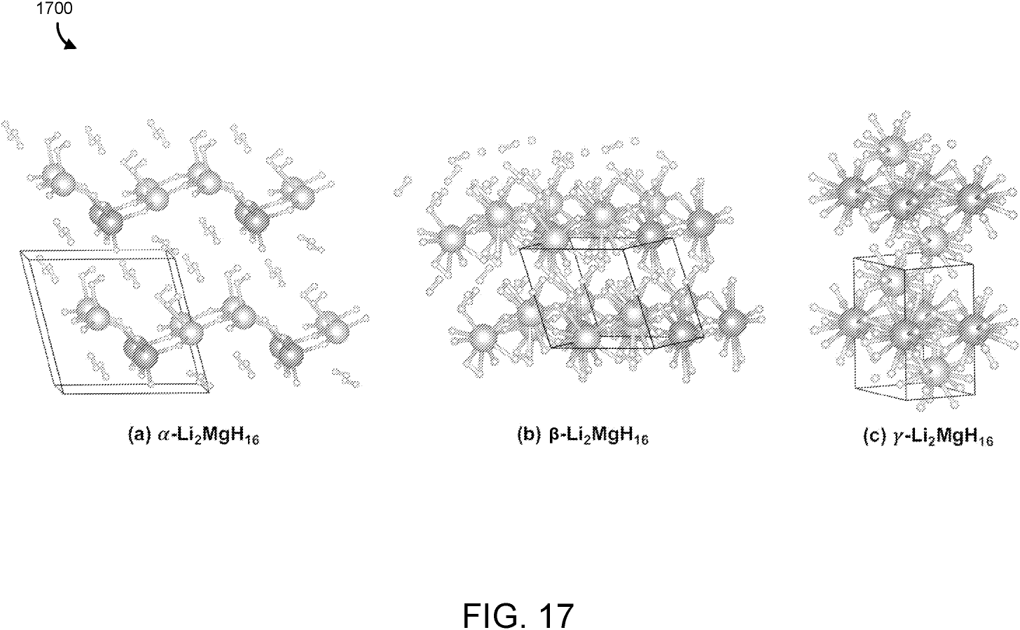

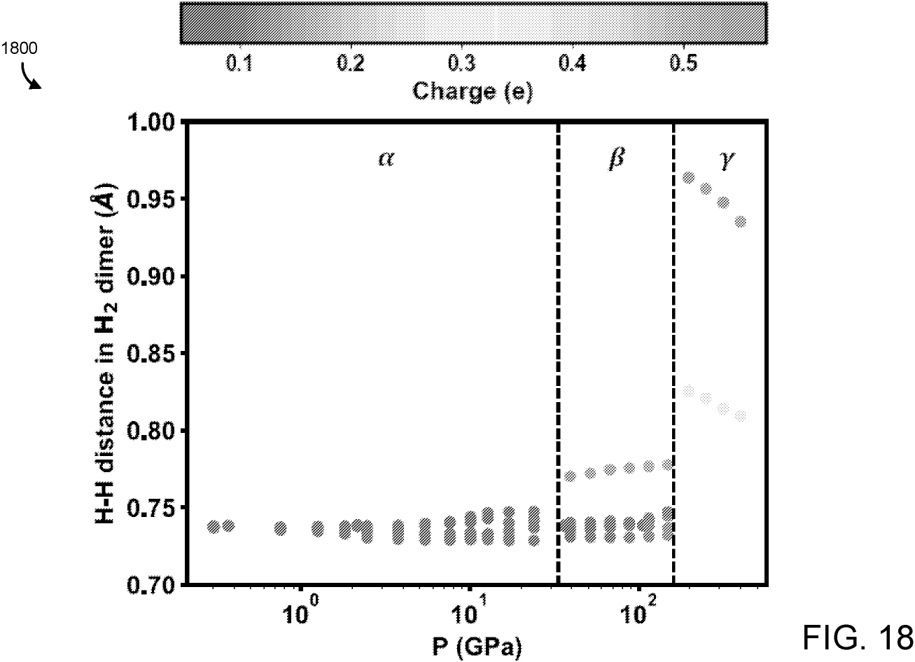

The crystal structures (collectively structures 1700) of the three polymorphs of Li₂MgH₁₆ are shown in FIG. 17. In FIG. 17, three structures are shown at different pressures. α-Li₂MgH₁₆ is shown at 0-33 GPa. β-Li₂MgH₁₆ is shown at 33-160 GPa. γ-Li₂MgH₁₆ is shown at >160 GPa. Both α-Li₂MgH₁₆ and β-Li₂MgH₁₆ (labeled in FIG. 17) have low symmetry with the P1 space group. α-Li₂MgH₁₆ includes periodic corrugated hydrogenated Li—Mg layers filled with hydrogen dimers in between. β-Li₂MgH₁₆ has also hydrogenated Li—Mg layers, but they are connected by sharing part of the coordinating hydrogen atoms to the metal atoms. Compared with the two phases at lower pressure regimes, γ-Li₂MgH₁₆ has higher symmetry with the P3ml space group. γ-Li₂MgH₁₆ has a 3D network consisting of Li/Mg-centered polyhedrons connected by the corner hydrogen atoms. Graph 1800 FIG. 18 reveals the effect of pressure on the H—H separation and the excess charge of all the H₂ dimers found in Li₂MgH₁₆. A larger H—H separation usually correlates with a higher excess charge. The effect of pressure is due to the polymorphic transitions. α-Li2MgH₁₆ and β-Li2MgH16 have H—H separations smaller than 0.8 and excess charge lower than 0.2e, while the maximum H—H separation and the excess charge in γ-Li₂MgH₁₆ achieve 0.97 and 0.57e, respectively.

Ternary Li—Mg superhydrides can thus be synthesized at modest pressures by the P² method. There are other factors, besides thermodynamics, influencing phase transitions not described here. The P² method is used for controlling phase stability as demonstrated. The P² method can be used to synthesize materials with new stoichiometries or materials with existing stoichiometries but novel structures. These new phases are coupled with an increased number of chemical constituents, shown by the preliminary case of the ternary Li—Mg—H system described herein.

In addition to previously described superhydrides, the following embodiments for C—S—H superhydrides and synthesis of those C—S—H superhydrides is now described. The C—S—H superhydrides are superhydrides that include C (carbon) and/or S (sulfur). Typically, these superhydrides satisfy x(H)-4*x(C)-2*x(S)>0, where x(H), x(C) and x(S) are compositions of H, C and S, respectively. A ternary C—S—H superhydride is a room-temperature superconductor, although at high pressures. Electrochemical synthesis of C—S—H superhydrides is performed in a similar manner to those previously described. The C—S—H superhydrides are both stable at relatively low pressures, such as less than 1 Gigapascal (GPa) and at relatively high temperatures, such as above 200 degrees Kelvin to approximately 400 degrees Kelvin.

A process for forming these C—S—H superhydrides is now described. The starting material, which can be carbon, or sulfur, or their mixture, is subjected to a hydrogen gas under a pressure. This mixture between carbon and sulfur can be in the form of a mechanical mixture, an alloying phase, or a compound (e.g. “black CS2”, polymeric C—S, etc.) The exact pressure de used depends on the composition of the starting material. The pressure also depends on the electrochemical process as previously described. A pressure process can be used to load hydrogen atoms into the C—S starting material. For example, hydrogen gas is sent into the C—S starting material at a high pressure. The process further includes an electrochemical process in combination with putting the C—S starting material under pressure. The electrochemical process enables lower pressures to be used during the pressurization of the C—S starting material. This facilitates development of the C—S—H superhydride, as high pressures can be difficult to work with and can produce unstable materials. The high-pressure process can also be costly and difficult to scale up to produce large numbers of C—S—H super hydrides.

The electrochemical process allows production of C—S—H hydrides that are stable at lower pressures, including pressures as low as several hundred megapascals (MPa). The electrochemical process is now described. The C—S electrode (or metal coated with C-S) is dipped or placed in a water and salt mixture (e.g., an electrolyte). An electric potential, typically between approximately -0.1 volts (V) and -1 V, on the reversible hydrogen electrode scale is applied to the C—S electrode. The hydrogen is loaded into C—S under these conditions.

Generally, combining the electrochemical process and the application of pressure to the C—S electrode can generate, from the C—S electrode, many different kinds of C—S—H superhydrides. The parameters of the pressure and the electric potential for producing each specific example can vary depending on the C—S composition chosen. Generally, these materials can be produced at ambient temperatures (e.g., about 300 degrees Kelvin). The materials are electrochemically loaded in the same scheme as previously described. The general reaction can be briefly represented by: CxSy + z(H⁺ + e-) → CxSyHz. This process thus describes a way to form all forms of superhydrides, metal superhydrides, non-metal and mixed metal non-metal superhydrides.

In some implementations, this embodiment includes a method for producing a superhydride, the method comprising: obtaining an electrode comprising one or more elements; obtaining an electrolyte comprising hydrogen atoms, the electrolyte configured to kinetically suppress a hydrogen evolution reaction in the electrode; disposing the electrode in the electrolyte; applying pressure to the electrode and the electrolyte while the electrode is disposed in the electrolyte; and forming, based on applying the pressure, a superhydride comprising a plurality of hydrogen atoms of the electrolyte being bonded to each of the one or more metal atoms of the metal electrode, the metal superhydride being stable at a pressure less than 100 Gigapascal (GPa).

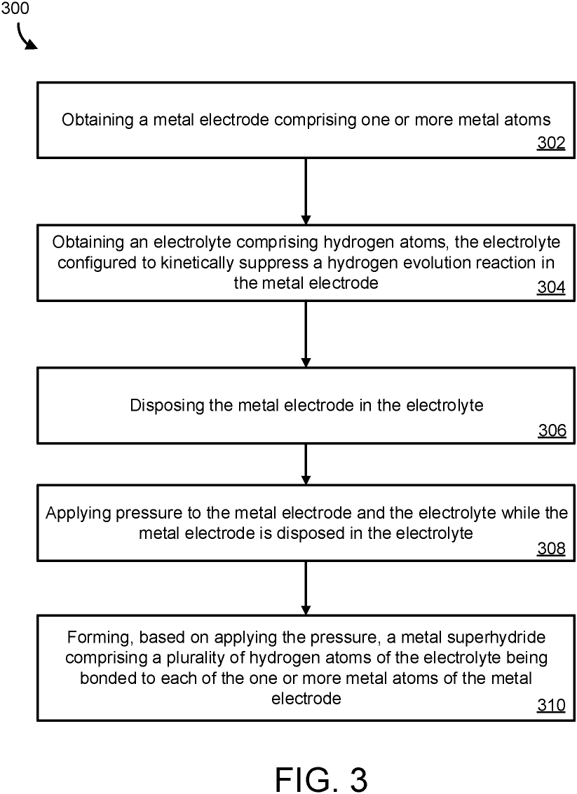

Turning to FIG. 3, a process 300 for producing metal superhydrides is shown. The process 300 includes obtaining (302) a metal electrode comprising one or more metal atoms. The process 300 includes obtaining (304) an electrolyte comprising hydrogen atoms, the electrolyte configured to kinetically suppress a hydrogen evolution reaction in the metal electrode. The process 300 includes disposing (306) the metal electrode in the electrolyte. The process 300 includes applying (308) pressure to the metal electrode and the electrolyte while the metal electrode is disposed in the electrolyte. The process 300 includes forming (310), based on applying the pressure, a metal superhydride comprising a plurality of hydrogen atoms of the electrolyte being bonded to each of the one or more metal atoms of the metal electrode, the metal superhydride being stable at a pressure less than 100 Gigapascal (GPa). Generally, the hydrogen atoms can be either H⁺, H⁻, or some combination thereof.

In some implementations, the process 300 includes adjusting, using the electrolyte, an activity of the plurality of hydrogen atoms in the metal electrode. The process 300 can include adjusting, based on the activity of the plurality of hydrogen atoms, kinetics of reactions of the plurality of hydrogen atoms at interfaces of the metal electrode and the electrolyte. The process 300 can include causing, based on the kinetics of the reactions, the plurality of hydrogen atoms of the electrolyte to be bonded to each of the one or more metal atoms of the metal electrode.

In some implementations, a number of hydrogen atoms in the plurality of hydrogen atoms that are being bonded to each of the one or more metal atoms is a function of a potential of the metal electrode. The process 300 can include applying the potential of the metal electrode to cause the metal superhydride to include a particular number of hydrogen atoms in the plurality, the particular number of hydrogen atoms being between 2 and 12 and inclusive of 2 and 12.

In some implementations, a number of hydrogen atoms in the plurality of hydrogen atoms that are being bonded to each of the one or more metal atoms is based on of a pH of the electrolyte. The process 300 can include adjusting the pH of the electrolyte to cause the metal superhydride to include a particular number of hydrogen atoms in the plurality, the particular number of hydrogen atoms being between 2 and 12 and inclusive of 2 and 12. In some implementations, the plurality of hydrogen atoms form an anion having a linear geometry. In some implementations, the plurality of hydrogen atoms form an anion having a planar geometry. In some implementations, the plurality of hydrogen atoms form an anion having a three dimensional (3D) geometry.

In some implementations, the metal electrode comprises Palladium, and the plurality of hydrogen atoms comprises at least three hydrogen atoms. In some implementations, the plurality of hydrogen atoms comprises twelve hydrogen atoms.

In some implementations, the metal electrode comprises at least one of: Lithium, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon. The electrolyte can include a proton-conducting membrane. The proton-conducting membrane can be selected from a group consisting of: an aqueous electrolyte solution, a polymer electrolyte membrane, a proton-conducting ceramic electrolyte, and a solid acid proton conductor or a hybrid electrolyte consisting of two of these groups. In some implementations, a pressure is less than 1 GPa for stability of the metal superhydride. In some implementations, the pressure is less than 500 MPa for stability of the metal superhydride. In some implementations, the one or more metal atoms of the metal electrode are a subset of all metal atoms of the metal electrode.

In some implementations, a metal superhydride (such as one produced from process 300 of FIG. 3), includes metal atoms forming a lattice, and a plurality of hydrogen atoms bonded to each of the metal atoms, wherein the plurality of hydrogen atoms are loaded into the lattice from an electrolyte configured to kinetically suppress a hydrogen evolution reaction in the lattice, wherein lattice is maintained at a pressure less than 100 gigapascal (GPa).

In some implementations, a number of hydrogen atoms in the plurality of hydrogen atoms that are being bonded to each of the metal atoms is a function of a potential of the lattice. In some implementations, the potential is between 0 and -1 volts on the reversible hydrogen electrode scale. In some implementations, a number of hydrogen atoms in the plurality of hydrogen atoms that are being bonded to each of the metal atoms is a function of a pH of the electrolyte. In some implementations, the plurality of hydrogen atoms form an anion having a linear geometry. In some implementations, the plurality of hydrogen atoms form an anion having a planar geometry. In some implementations, the plurality of hydrogen atoms form an anion having a three dimensional (3D) geometry.

In some implementations, the lattice comprises Palladium, and wherein the plurality of hydrogen atoms comprises at least three hydrogen atoms. In some implementations, the plurality of hydrogen atoms comprises exactly twelve hydrogen atoms. In some implementations, the lattice comprises at least one of: Lithium, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon. In some implementations: the lattice is a binary metal alloy with the elements containing: Lithium, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon.

In some implementations, the electrolyte comprises a proton-conducting membrane. In some implementations, the proton-conducting membrane is selected from a group consisting of: an aqueous electrolyte solution, a polymer electrolyte membrane, a proton-conducting ceramic electrolyte, and a solid acid proton conductor. In some implementations, the proton-conducting membrane is a selection of two components from the group consisting of: an aqueous electrolyte solution, a polymer electrolyte membrane, a proton-conducting ceramic electrolyte, and a solid acid proton conductor. In some implementations, the metal superhydride is stable at a pressure less than 1 GPa. In some implementations, the metal superhydride is stable at a pressure less than 500 MPa.

In some implementations, the metal atoms of the lattice are a subset of all metal atoms of the lattice. In some implementations, the plurality of hydrogen atoms comprises between 2and 12 hydrogen atoms inclusive of 2 and 12 hydrogen atoms.

In some implementations, the lattice comprises Palladium, wherein at least one metal atom of the lattice is bonded to ten of the hydrogen atoms to form PdH₁₀, and wherein the pressure is less than 200 MPa.

In some implementations, the lattice comprises Yttrium, wherein at least one metal atom of the lattice is bonded to nine of the hydrogen atoms to form YH₉, wherein the pressure is approximately 1 MPa, and wherein the lattice is at an electric potential of approximately -0.2 volts.

In some implementations, the lattice comprises Lanthanum, wherein at least one metal atom of the lattice is bonded to eight of the hydrogen atoms to form LaHs, wherein the pressure is approximately 1 GPa, and wherein the lattice is at an electric potential of approximately -0.2 volts.

In some implementations, the lattice comprises Magnesium, wherein at least one metal atom of the lattice is bonded to sixteen of the hydrogen atoms to form MgH₁₆, wherein the pressure is approximately 100 MPa, and wherein the lattice is at an electric potential of approximately -0.2 volts.

In some implementations, the lattice comprises Calcium, and wherein at least one metal atom of the lattice is bonded to six of the hydrogen atoms to form CaH₆.

Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, the modeling environment of FIG. 1, or the computing system 1400, can be implemented using digital electronic circuitry, or in computer software, firmware, or hardware, or in combinations of one or more of them.

Some implementations described in this specification (e.g., the model 100, etc.) can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. In some implementations, the query response module 104 and/or the data structure module 106 comprises a data processing apparatus as described herein. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

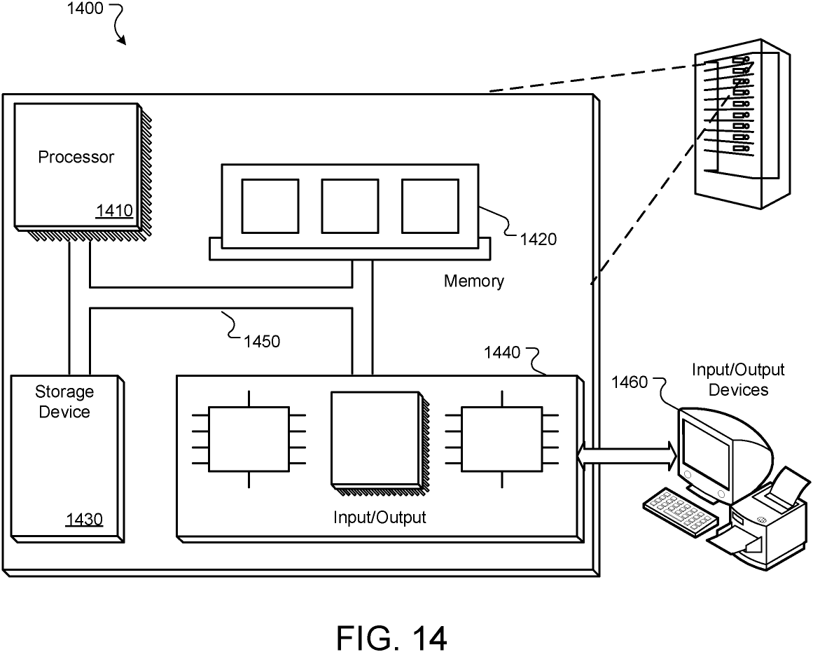

FIG. 14 shows an example computer system 1400 that includes a processor 1410, a memory 1420, a storage device 1430 and an input/output device 1440. Each of the components 1410, 1420, 1430 and 1440 can be interconnected, for example, by a system bus 1450. The processor 1410 is capable of processing instructions for execution within the system 1400. In some implementations, the processor 1410 is a single-threaded processor, a multi-threaded processor, or another type of processor. The processor 1410 is capable of processing instructions stored in the memory 1420 or on the storage device 1430. The memory 1420 and the storage device 1430 can store information within the system 1400.

The input/output device 1440 provides input/output operations for the system 1400. In some implementations, the input/output device 1440 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 1460. In some implementations, mobile computing devices, mobile communication devices, and other devices can be used.

While this specification includes many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications may be made without departing from the spirit and scope of the data processing system described herein. Accordingly, other embodiments are within the scope of the following claims.

What is claimed is:

1. A method for producing a metal superhydride, the method comprising:
obtaining a metal electrode comprising one or more metal atoms;
obtaining an electrolyte comprising hydrogen atoms, the electrolyte configured to kinetically suppress a hydrogen evolution reaction in the metal electrode;
disposing the metal electrode in the electrolyte;
applying pressure to the metal electrode and the electrolyte while the metal electrode is disposed in the electrolyte; and
forming, based on applying the pressure, a metal superhydride comprising a plurality of hydrogen atoms of the electrolyte being bonded to each of the one or more metal atoms of the metal electrode, the metal superhydride being stable at a pressure less than 100 gigapascal (GPa).

2. The method of claim 1, further comprising:
adjusting, using the electrolyte, an activity of the plurality of hydrogen atoms in the metal electrode;
adjusting, based on the activity of the plurality of hydrogen atoms, kinetics of reactions of the plurality of hydrogen atoms at interfaces of the metal electrode and the electrolyte; and
causing, based on the kinetics of the reactions, the plurality of hydrogen atoms of the electrolyte to be bonded to each of the one or more metal atoms of the metal electrode.

3. The method of claim 1, wherein a number of hydrogen atoms in the plurality of hydrogen atoms that are being bonded to each of the one or more metal atoms is a function of a potential of the metal electrode, wherein the method further comprises:
applying the potential of the metal electrode to cause the metal superhydride to include a particular number of hydrogen atoms in the plurality, the particular number of hydrogen atoms being between 2 and 12 and inclusive of 2 and 12.

4. The method of claim 1, wherein a number of hydrogen atoms in the plurality of hydrogen atoms that are being bonded to each of the one or more metal atoms is based on of a pH of the electrolyte, wherein the method further comprises:
adjusting the pH of the electrolyte to cause the metal superhydride to include a particular number of hydrogen atoms in the plurality, the particular number of hydrogen atoms being between 2 and 12 and inclusive of 2 and 12 .

5. The method of claim 1, wherein the plurality of hydrogen atoms form an anion having a linear geometry.

6. The method of claim 1, wherein the plurality of hydrogen atoms form an anion having a planar geometry.

7. The method of claim 1, wherein the plurality of hydrogen atoms form an anion having a three dimensional (3D) geometry.

8. The method of claim 1, wherein the metal electrode comprises Palladium, and wherein the plurality of hydrogen atoms comprises at least three hydrogen atoms.

9. The method of claim 8, wherein the plurality of hydrogen atoms comprises twelve hydrogen atoms.

10. The method of claim 1, wherein the metal electrode comprises at least one of:
Lithium, Carbon, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon.

11. The method of claim 1, wherein the electrolyte comprises a proton-conducting membrane.

12. The method of claim 11, wherein the proton-conducting membrane is selected from a group consisting of: an aqueous electrolyte solution, a polymer electrolyte membrane, a proton-conducting ceramic electrolyte, and a solid acid proton conductor.

13. The method of claim 1, wherein the pressure is less than 1 GPa.

14. The method of claim 1, wherein the pressure is less than 500 MPa.

15. The method of claim 1, wherein the one or more metal atoms of the metal electrode are a subset of all metal atoms of the metal electrode.

16. A metal electrode device comprising:
metal atoms forming a lattice; and
a plurality of hydrogen atoms bonded to each of the metal atoms, wherein the plurality of hydrogen atoms are loaded into the lattice from an electrolyte configured to kinetically suppress a hydrogen evolution reaction in the lattice,
wherein lattice is maintained at a pressure less than 100 gigapascal (GPa).

17. The metal electrode device of claim 16, wherein a number of hydrogen atoms in the plurality of hydrogen atoms that are being bonded to each of the metal atoms is a function of a potential of the lattice.

18. The metal electrode device of claim 17, wherein the potential is between 0 and -1 volts.

19. The metal electrode device of claim 16, wherein a number of hydrogen atoms in the plurality of hydrogen atoms that are being bonded to each of the metal atoms is a function of a pH of the electrolyte.

20. The metal electrode device of claim 16, wherein the plurality of hydrogen atoms form an anion having a linear geometry.

21. The metal electrode device of claim 16, wherein the plurality of hydrogen atoms form an anion having a planar geometry.

22. The metal electrode device of claim 16, wherein the plurality of hydrogen atoms form an anion having a three dimensional (3D) geometry.

23. The metal electrode device of claim 16, wherein the lattice comprises Palladium, and wherein the plurality of hydrogen atoms comprises at least three hydrogen atoms.

24. The metal electrode device of claim 23, wherein the plurality of hydrogen atoms comprises exactly twelve hydrogen atoms.

25. The metal electrode device of claim 16, wherein the lattice comprises at least one of:
Lithium, Carbon, Yttrium, Selenium, Sulfur, Iron, Barium, Calcium, Lanthanum, Cerium, Praseodymium, Thorium, Sodium, Cesium, Magnesium, Scandium, Aluminum, Gallium, Indium, Germanium, Arsenic, Bismuth, Iodine, Xenon, Tellurium, Lead, and Silicon.

26. The metal electrode device of claim 16, wherein the electrolyte comprises a proton-conducting membrane.

27. The metal electrode device of claim 26, wherein the proton-conducting membrane is selected from a group consisting of: an aqueous electrolyte solution, a polymer electrolyte membrane, a proton-conducting ceramic electrolyte, and a solid acid proton conductor.

28. The metal electrode device of claim 16, wherein the pressure is less than 1 GPa.

29. The metal electrode device of claim 16, wherein the pressure is less than 500 MPa.

30. The metal electrode device of claim 16, wherein the metal atoms of the lattice are a subset of all metal atoms of the lattice.

31. The metal electrode device of claim 16, wherein the plurality of hydrogen atoms comprises between 2 and 12 hydrogen atoms inclusive of 2 and 12 hydrogen atoms.

32. The metal electrode device of claim 16, wherein the lattice comprises Palladium, wherein at least one metal atom of the lattice is bonded to ten of the hydrogen atoms to form PdH₁₀, and wherein the pressure is less than 200 MPa.

33. The metal electrode device of claim 16, wherein the lattice comprises Yttrium, wherein at least one metal atom of the lattice is bonded to nine of the hydrogen atoms to form YH₉, wherein the pressure is approximately 1 MPa, and wherein the lattice is at an electric potential of approximately -0.2 volts on the reversible hydrogen electrode scale.

34. The metal electrode device of claim 16, wherein the lattice comprises Lanthanum, wherein at least one metal atom of the lattice is bonded to eight of the hydrogen atoms to form LaHs, wherein the pressure is approximately 1 GPa, and wherein the lattice is at an electric potential of approximately -0.2 volts on the reversible hydrogen electrode scale.

35. The metal electrode device of claim 16, wherein the lattice comprises Magnesium, wherein at least one metal atom of the lattice is bonded to sixteen of the hydrogen atoms to form MgH₁₆, wherein the pressure is approximately 100 MPa, and wherein the lattice is at an electric potential of approximately -0.2 volts.

36. The metal electrode device of claim 16, wherein the lattice comprises Calcium, and wherein at least one metal atom of the lattice is bonded to six of the hydrogen atoms to form CaH₆.

37. A method comprising:
obtaining a metal electrode comprising one or more metal atoms;
obtaining an electrolyte comprising hydrogen atoms, the electrolyte configured to kinetically suppress a hydrogen evolution reaction in the electrode;
disposing the electrode in the electrolyte;
applying pressure to the electrode and the electrolyte while the electrode is disposed in the electrolyte; and
forming, based on applying the pressure, a superhydride comprising a plurality of hydrogen atoms of the electrolyte being bonded to each of the one or more metal atoms of the metal electrode, the metal superhydride being stable at a pressure less than 100 Gigapascal (GPa).
